(19) United States
(12) Patent Application Publication
(10) Pub. No.: US 2012/0008684 A1
(43) Pub. Date: Jan. 12, 2012

(54) METHOD AND APPARATUS OF ENCODING AND DECODING VIDEO SIGNAL

(75) Inventors: Bae-keun LEE, Bucheon-si (KR); Yu-mi SOHN, Seoul (KR); Kyo-hyuk LEE, Yongin-si (KR)

(73) Assignee: SAMSUNG ELECTRONICS CO., LTD., Suwon-si (KR)

(21) Appl. No.: 13/179,757

(22) Filed: Jul. 11, 2011

Related U.S. Application Data
(60) Provisional application No. 61/362,780, filed on Jul. 9, 2010.

(30) Foreign Application Priority Data
Jan. 18, 2011 (KR) 10-2011-0005004

(51) Int. Cl. H04N 11/02

(52) U.S. Cl. 375/240.12; 375/E07.243

(57) ABSTRACT

Provided are methods and apparatuses for encoding and decoding a video including a plurality of color components. The method of encoding includes: splitting a first color component block and neighboring pixels of the first color component block into N segments, where N is an integer, based on pixel values of the first color component block which have been previously encoded and then restored; splitting a second color component block, corresponding to the first color component block, and neighboring pixels of the second color component block into N segments according to the N segments of the first color component block and the neighboring pixels of the first color component block; predicting the N segments of the second color component block by using the neighboring pixels of the second color component block split into the N segments; and encoding the second color component block, based on a result of the prediction.

### CROSS-REFERENCE TO RELATED PATENT APPLICATIONS

This application claims the benefit of U.S. Provisional Patent Application No. 61/362,780, filed on Jul. 9, 2010 in the U.S. Patent and Trademark Office, and claims priority from Korean Patent Application No. 10-2011-0005004, filed on Jan. 18, 2011 in the Korean Intellectual Property Office, the disclosures of which are incorporated herein in their entireties by reference.

### BACKGROUND

1. Field

Apparatuses and methods consistent with exemplary embodiments relate to encoding and decoding a video including still images and moving pictures, and more particularly, to encoding a video signal by using a correlation among a plurality of color components, and decoding a video signal by using a correlation among a plurality of color components.

2. Description of the Related Art

In an image encoding method such as MPEG-1, MPEG-2, MPEG-4 H.264/MPEG-4 Advanced Video coding (AVC), or the like, an image is divided into blocks each having a predetermined size so as to be encoded. Then, each of the blocks is prediction-encoded by using inter prediction or intra prediction.

A prediction block generated by inter prediction or intra prediction is subtracted from the original block to produce a residual block, and the residual block undergoes discrete cosine transformation, quantization, and entropy encoding to produce a bitstream.

In a related art image encoding method, an image is encoded using a plurality of color components. A single pixel is represented by a luminance component and a chrominance component, and the luminance component and the chrominance component are each encoded. The chrominance component may include a chrominance component Cb for blue and a chrominance component Cr for red.

### SUMMARY

Aspects of exemplary embodiments provide a prediction encoding method, a prediction encoding apparatus, a prediction decoding method, and a prediction decoding apparatus, by which compression efficiency of a video signal including a plurality of color components is improved using a correlation among the color components when the video signal is encoded.

According to an aspect of an exemplary embodiment, there is provided a method of encoding a video signal including a plurality of color components, the method including: splitting a first color component block and neighboring pixels of the first color component block into N segments, based on pixel values of the first color component block which have been previously encoded and then restored, wherein N is an integer; splitting a second color component block corresponding to the first color component block and neighboring pixels of the second color component block into N segments according to the N segments of the first color component block and the neighboring pixels of the first color component block; predicting the N segments of the second color component block by using the neighboring pixels of the second color component block split into the N segments; and encoding the second color component block, based on a result of the predicting.

According to an aspect of another exemplary embodiment, there is provided a method of decoding a video signal including a plurality of color components, the method including: splitting a first color component block and neighboring pixels of the first color component block into N segments, based on pixel values of the first color component block which have been previously decoded, wherein N is an integer; splitting a second color component block corresponding to the first color component block and neighboring pixels of the second color component block into N segments according to the N segments of the first color component block and the neighboring pixels of the first color component block; predicting the N segments of the second color component block by using the neighboring pixels of the second color component block split into the N segments; and decoding the second color component block, based on a result of the predicting.

According to an aspect of another exemplary embodiment, there is provided an apparatus for encoding a video signal including a plurality of color components, the apparatus including: a splitter which splits a first color component block and neighboring pixels of the first color component block into N segments, based on pixel values of the first color component block which have been previously encoded and then restored, and splits a second color component block corresponding to the first color component block and neighboring pixels of the second color component block into N segments according to the N segments of the first color component block and the neighboring pixels of the first color component block, wherein N is an integer; and a predictor which predicts the N segments of the second color component block by using the neighboring pixels of the second color component block split into the N segments.

According to an aspect of another exemplary embodiment, there is provided an apparatus for decoding a video signal including a plurality of color components, the apparatus including: a splitter which splits a first color component block and neighboring pixels of the first color component block into N segments, based on pixel values of the first color component block which have been previously decoded, and splits a second color component block corresponding to the first color component block and neighboring pixels of the second color component block into N segments according to the N segments of the first color component block and the neighboring pixels of the first color component block, wherein N is an integer; and a predictor which predicts the N segments of the second color component block by using the neighboring pixels of the second color component block split into the N segments.

### BRIEF DESCRIPTION OF THE DRAWINGS

The above and other features and advantages will become more apparent by describing in detail exemplary embodiments with reference to the attached drawings in which:

FIG. 1 is a block diagram of a video encoding apparatus according to an exemplary embodiment;

FIG. 2 is a block diagram of a video decoding apparatus according to an exemplary embodiment;

FIG. 3 is a diagram for describing a concept of coding units according to an exemplary embodiment;

FIG. 4 is a block diagram of an image encoder based on coding units, according to an exemplary embodiment;

FIG. 5 is a block diagram of an image decoder based on coding units, according to an exemplary embodiment;

FIG. 6 is a diagram illustrating deeper coding units according to depths, and partitions, according to an exemplary embodiment;

FIG. 7 is a diagram for describing a relationship between a coding unit and transformation units, according to an exemplary embodiment;

FIG. 8 is a diagram for describing encoding information of coding units corresponding to a coded depth, according to an exemplary embodiment;

FIG. 9 is a diagram of deeper coding units according to depths, according to an exemplary embodiment;

FIGS. 10, 11, and 12 are diagrams for describing a relationship between coding units, prediction units, and transformation units, according to an exemplary embodiment;

FIG. 13 is a diagram for describing a relationship between a coding unit, a prediction unit or a partition, and a transformation unit, according to encoding mode information of Table 1;

FIG. 14 is a block diagram of a video encoding apparatus for encoding a video signal including a plurality of color components, according to an exemplary embodiment;

FIGS. 15A through 15C are reference diagrams illustrating color formats including a plurality of color components, according to an exemplary embodiment;

FIGS. 16A and 16B are reference diagrams illustrating luminance blocks and chrominance blocks according to color formats according to an exemplary embodiment;

FIG. 17 is a reference diagram for illustrating a process of splitting a first color component block and its neighboring pixel and a process of splitting a second color component block and its neighboring pixel by using the splitting of the first color component block and its neighboring pixel, according to an exemplary embodiment;

FIG. 18 is a reference diagram for illustrating a first color component block and its neighboring pixels according to an embodiment of the present invention, and FIG. 19 is a reference diagram for illustrating segments into which a first color component block and its neighboring pixels are split, according to an exemplary embodiment;

FIG. 20 is a reference diagram for illustrating a process of reducing a first color component block and its neighboring pixel according to the size of a second color component block corresponding to the first color component block, according to an exemplary embodiment;

FIG. 21 is a reference diagram for illustrating a process of determining segment information of the neighboring pixels of a second color component block from segment information of the neighboring pixels of a first color component block, according to an exemplary embodiment;

FIG. 22 is a reference diagram for illustrating a method of processing a first color component block located on a picture boundary, according to an exemplary embodiment;

FIG. 23 is a reference diagram for illustrating a process of post-processing a prediction block of a second color component block, according to an exemplary embodiment;

FIG. 24 is a flowchart illustrating a video encoding method according to an exemplary embodiment; and

FIG. 25 is a flowchart illustrating a video decoding method according to an exemplary embodiment.

### DETAILED DESCRIPTION OF EXEMPLARY EMBODIMENTS

Exemplary embodiments will now be described more fully with reference to the accompanying drawings, in which like reference numerals refer to like elements throughout.

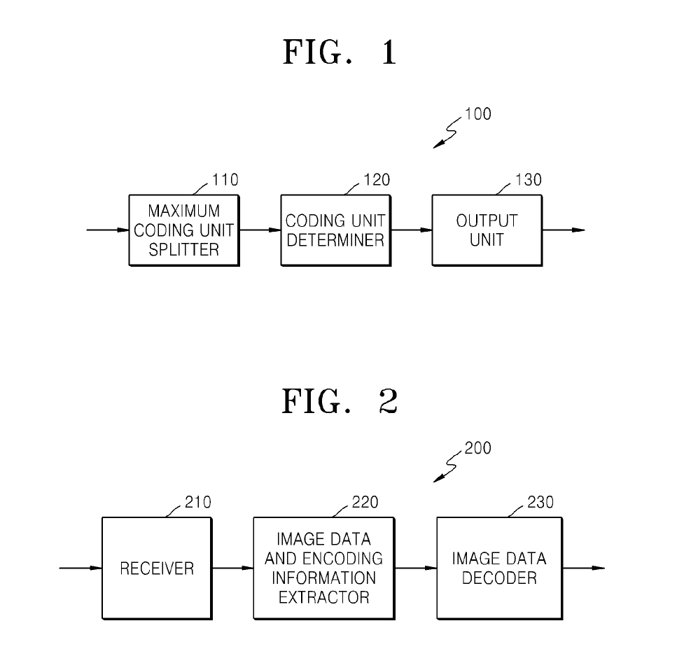

FIG. 1 is a block diagram of a video encoding apparatus 100 according to an exemplary embodiment.

A video encoding apparatus 100 according to an exemplary embodiment includes a maximum coding unit splitter 110, a coding unit determiner 120, and an output unit 130.

The maximum coding unit splitter 110 may split a current picture based on a maximum coding unit for the current picture of an image. If the current picture is larger than the maximum coding unit, image data of the current picture may be split into the at least one maximum coding unit. The maximum coding unit according to an exemplary embodiment may be a data unit having a size of 32×32, 64×64, 128×128, 256×256, etc., wherein a shape of the data unit is a square having a width and length in power of 2 that are greater than 8. The image data may be output to the coding unit determiner 120 according to the at least one maximum coding unit.

A coding unit according to an exemplary embodiment may be characterized by a maximum size and a depth. The depth denotes a number of times the coding unit is spatially split from the maximum coding unit, and as the depth deepens, deeper encoding units according to depths may be split from the maximum coding unit to a minimum coding unit. A depth of the maximum coding unit is an uppermost depth and a depth of the minimum coding unit is a lowermost depth. Since a size of a coding unit corresponding to each depth decreases as the depth of the maximum coding unit deepens, a coding unit corresponding to an upper depth may include a plurality of coding units corresponding to lower depths.

As described above, the image data of the current picture is split into the maximum coding units according to a maximum size of the coding unit, and each of the maximum coding units may include deeper coding units that are split according to depths. Since the maximum coding unit according to an exemplary embodiment is split according to depths, the image data of a spatial domain included in the maximum coding unit may be hierarchically classified according to depths.

A maximum depth and a maximum size of a coding unit, which limit the total number of times a height and a width of the maximum coding unit are hierarchically split, may be predetermined.

The coding unit determiner 120 encodes at least one split region obtained by splitting a region of the maximum coding unit according to depths, and determines a depth to output a finally encoded image data according to the at least one split region. In other words, the coding unit determiner 120 determines a coded depth by encoding the image data in the deeper coding units according to depths, according to the maximum coding unit of the current picture, and selecting a depth having the least encoding error. Thus, the encoded image data of the coding unit corresponding to the determined coded depth is finally output. Also, the coding units corresponding to the coded depth may be regarded as encoded coding units.

The determined coded depth and the encoded image data according to the determined coded depth are output to the output unit 130.

The image data in the maximum coding unit is encoded based on the deeper coding units corresponding to at least one depth equal to or below the maximum depth, and results of encoding the image data are compared based on each of the deeper coding units. A depth having the least encoding error may be selected after comparing encoding errors of the deeper coding units. At least one coded depth may be selected for each maximum coding unit.

The size of the maximum coding unit is split as a coding unit is hierarchically split according to depths, and as the number of coding units increases. Also, even if coding units correspond to the same depth in one maximum coding unit, it is determined whether to split each of the coding units corresponding to the same depth to a lower depth by measuring an encoding error of the image data of the each coding unit, separately. Accordingly, even when image data is included in one maximum coding unit, the image data is split to regions according to the depths and the encoding errors may differ according to regions in the one maximum coding unit, and thus the coded depths may differ according to regions in the image data. Thus, one or more coded depths may be determined in one maximum coding unit, and the image data of the maximum coding unit may be divided according to coding units of at least one coded depth.

Accordingly, the coding unit determiner 120 may determine coding units having a tree structure included in the maximum coding unit. The ‘coding units having a tree structure’ according to an exemplary embodiment include coding units corresponding to a depth determined to be the coded depth, from among all deeper coding units included in the maximum coding unit. A coding unit of a coded depth may be hierarchically determined according to depths in the same region of the maximum coding unit, and may be independently determined in different regions. Similarly, a coded depth in a current region may be independently determined from a coded depth in another region.

A maximum depth according to an exemplary embodiment is an index related to the number of splitting times from a maximum coding unit to a minimum coding unit. A first maximum depth according to an exemplary embodiment may denote the total number of splitting times from the maximum coding unit to the minimum coding unit. A second maximum depth according to an exemplary embodiment may denote the total number of depth levels from the maximum coding unit to the minimum coding unit. For example, when a depth of the maximum coding unit is 0, a depth of a coding unit, in which the maximum coding unit is split once, may be set to 1, and a depth of a coding unit, in which the maximum coding unit is split twice, may be set to 2. Here, if the minimum coding unit is a coding unit in which the maximum coding unit is split four times, 5 depth levels of depths 0, 1, 2, 3 and 4 exist, and thus the first maximum depth may be set to 4, and the second maximum depth may be set to 5.

Prediction encoding and transformation may be performed according to the maximum coding unit. The prediction encoding and the transformation are also performed based on the deeper coding units according to a depth equal to or depths less than the maximum depth, according to the maximum coding unit.

Since the number of deeper coding units increases whenever the maximum coding unit is split according to depths, encoding including the prediction encoding and the transformation is performed on all of the deeper coding units generated as the depth deepens. For convenience of description, the prediction encoding and the transformation will now be described based on a coding unit of a current depth, in a maximum coding unit.

The video encoding apparatus 100 may variously select a size or shape of a data unit for encoding the image data. In order to encode the image data, operations, such as prediction encoding, transformation, and entropy encoding, are performed, and at this time, the same data unit may be used for all operations or different data units may be used for each operation.

For example, the video encoding apparatus 100 may select not only a coding unit for encoding the image data, but also a data unit different from the coding unit so as to perform the prediction encoding on the image data in the coding unit.

In order to perform prediction encoding in the maximum coding unit, the prediction encoding may be performed based on a coding unit corresponding to a coded depth, i.e., based on a coding unit that is no longer split to coding units corresponding to a lower depth. Hereinafter, the coding unit that is no longer split and becomes a basis unit for prediction encoding will now be referred to as a ‘prediction unit’. A partition obtained by splitting the prediction unit may include a prediction unit or a data unit obtained by splitting at least one of a height and a width of the prediction unit.

For example, when a coding unit of 2N×2N (where N is a positive integer) is no longer split and becomes a prediction unit of 2N×2N, and a size of a partition may be 2N×2N, 2N×N, N×2N, or N×N. Examples of a partition type include symmetrical partitions that are obtained by symmetrically splitting a height or width of the prediction unit, partitions obtained by asymmetrically splitting the height or width of the prediction unit, such as 1:n or n:1, partitions that are obtained by geometrically splitting the prediction unit, and partitions having arbitrary shapes.

A prediction mode of the prediction unit may be at least one of an intra mode, a inter mode, and a skip mode. For example, the intra mode or the inter mode may be performed on the partition of 2N×2N, 2N×N, N×2N, or N×N. Also, the skip mode may be performed only on the partition of 2N×2N. The encoding is independently performed on one prediction unit in a coding unit, thereby selecting a prediction mode having a least encoding error.

The video encoding apparatus 100 may also perform the transformation on the image data in a coding unit based not only on the coding unit for encoding the image data, but also based on a data unit that is different from the coding unit.

In order to perform the transformation in the coding unit, the transformation may be performed based on a data unit having a size smaller than or equal to the coding unit. For example, the data unit for transformation may include a data unit for an intra mode and a data unit for an inter mode.

The data unit for transformation may be hereinafter referred to as a transformation unit. Similarly to the coding unit, the transformation unit in the coding unit may be recursively split into smaller sized regions, and thus residual data in the coding unit may be divided according to the transformation having the tree structure according to transformation depths.

A transformation depth indicating the number of splitting times to reach the transformation unit by splitting the height and width of the coding unit may also be set in the transformation unit. For example, in a current coding unit of 2N×2N, a transformation depth may be 0 when the size of a transformation unit is also 2N×2N, may be 1 when each of the height and width of the current coding unit is split into two equal parts, totally split into 4 transformation units, and the size of the transformation unit is thus N×N, and may be 2 when each of the height and width of the current coding unit is split into four equal parts, totally split into 4² transformation units and the size of the transformation unit is thus N/2×N/2. For example, the transformation unit may be set according to a hierarchical tree structure, in which a transformation unit of an upper transformation depth is split into four transformation units of a lower transformation depth according to the hierarchical characteristics of a transformation depth.

Similarly to the coding unit, the transformation unit in the coding unit may be recursively split into smaller sized regions, so that the transformation unit may be determined independently in units of regions. Thus, residual data in the coding unit may be divided according to the transformation having the tree structure according to transformation depths.

Encoding information according to coding units corresponding to a coded depth requires not only information about the coded depth, but also about information related to prediction encoding and transformation. Accordingly, the coding unit determiner 120 not only determines a coded depth having a least encoding error, but also determines a partition type in a prediction unit, a prediction mode according to prediction units, and a size of a transformation unit for transformation.

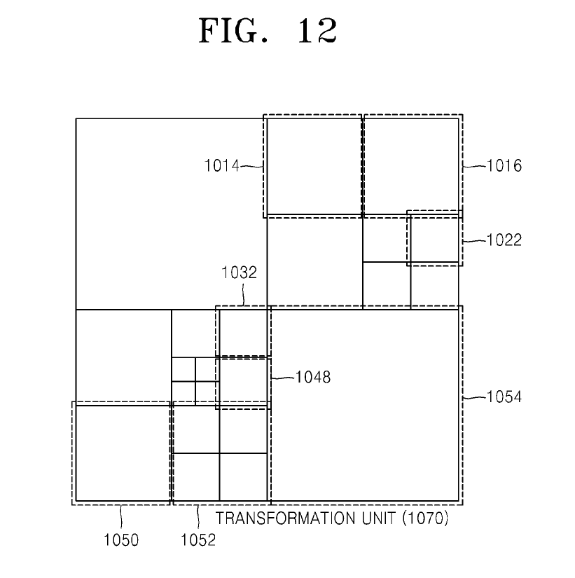

Coding units according to a tree structure in a maximum coding unit and a method of determining a partition, according to exemplary embodiments, will be described in detail later with reference to FIGS. 2 and 12.

The coding unit determiner 120 may measure an encoding error of deeper coding units according to depths by using Rate-Distortion Optimization based on Lagrangian multipliers.

The output unit 130 outputs the image data of the maximum coding unit, which is encoded based on the at least one coded depth determined by the coding unit determiner 120, and information about the encoding mode according to the coded depth, in bitstreams.

The encoded image data may be obtained by encoding residual data of an image.

The information about the encoding mode according to coded depth may include information about the coded depth, about the partition type in the prediction unit, the prediction mode, and the size of the transformation unit.

The information about the coded depth may be defined by using split information according to depths, which indicates whether encoding is performed on coding units of a lower depth instead of a current depth. If the current depth of the current coding unit is the coded depth, image data in the current coding unit is encoded and output, and thus the split information may be defined not to split the current coding unit to a lower depth. Alternatively, if the current depth of the current coding unit is not the coded depth, the encoding is performed on the coding unit of the lower depth, and thus the split information may be defined to split the current coding unit to obtain the coding units of the lower depth.

If the current depth is not the coded depth, encoding is performed on the coding unit that is split into the coding unit of the lower depth. Since at least one coding unit of the lower depth exists in one coding unit of the current depth, the encoding is repeatedly performed on each coding unit of the lower depth, and thus the encoding may be recursively performed for the coding units having the same depth.

Since the coding units having a tree structure are determined for one maximum coding unit, and information about at least one encoding mode is determined for a coding unit of a coded depth, information about at least one encoding mode may be determined for one maximum coding unit. Also, a coded depth of the image data of the maximum coding unit may be different according to locations since the image data is hierarchically split according to depths, and thus information about the coded depth and the encoding mode may be set for the image data.

Accordingly, the output unit 130 may assign encoding information about a corresponding coded depth and an encoding mode to at least one of the coding unit, the prediction unit, and a minimum unit included in the maximum coding unit.

The minimum unit according to an exemplary embodiment is a rectangular data unit obtained by splitting the minimum coding unit constituting the lowermost depth by 4. Alternatively, the minimum unit may be a maximum rectangular data unit that may be included in all of the coding units, prediction units, and transformation units included in the maximum coding unit.

For example, the encoding information output through the output unit 130 may be classified into encoding information according to coding units, and encoding information according to prediction units. The encoding information according to the coding units may include the information about the prediction mode and about the size of the partitions. The encoding information according to the prediction units may include information about an estimated direction of an inter mode, about a reference image index of the inter mode, about a motion vector, about a chroma component of an intra mode, and about an interpolation method of the intra mode. Also, information about a maximum size of the coding unit defined according to pictures, slices, or groups of pictures (GOPs), and information about a maximum depth may be inserted into a header of a bitstream.

In the video encoding apparatus 100, the deeper coding unit may be a coding unit obtained by dividing a height or width of a coding unit of an upper depth, which is one layer above, by two. In other words, when the size of the coding unit of the current depth is 2N×2N, the size of the coding unit of the lower depth is N×N. Also, the coding unit of the current depth having the size of 2N×2N may include maximum 4 of the coding unit of the lower depth.

Accordingly, the video encoding apparatus 100 may form the coding units having the tree structure by determining coding units having an optimum shape and an optimum size for each maximum coding unit, based on the size of the maximum coding unit and the maximum depth determined considering characteristics of the current picture. Also, since encoding may be performed on each maximum coding unit by using any one of various prediction modes and transformations, an optimum encoding mode may be determined considering characteristics of the coding unit of various image sizes.

Accordingly, when an image having a very high resolution or a large amount of data is encoded in units of existing macroblocks, the number of macroblocks required for each pixel excessively increases. Thus, the amount of compression information generated for each macroblock also increases, and accordingly, the load of transmitting the compression information tends to increase and data compression efficiency tends to decrease. Accordingly, the video encoding apparatus 100 may increase a maximum size of a coding unit in consideration of the size of the image and adjust a coding unit in consideration of image characteristics, whereby image compression efficiency may increase.

FIG. 2 is a block diagram of a video decoding apparatus 200 according to an exemplary embodiment.

A video decoding apparatus 200 according to an exemplary embodiment includes a receiver 210, an image data and encoding information extractor 220, and an image data decoder 230. Definitions of various terms, such as a coding unit, a depth, a prediction unit, a transformation unit, and information about various encoding modes, for various operations of the video decoding apparatus 200 are identical to those described with reference to FIG. 1 and the video encoding apparatus 100.

The receiver 210 receives and parses a bitstream of an encoded video. The image data and encoding information extractor 220 extracts encoded image data for each coding unit from the parsed bitstream, wherein the coding units have a tree structure according to each maximum coding unit, and outputs the extracted image data to the image data decoder 230. The image data and encoding information extractor 220 may extract information about a maximum size of a coding unit of a current picture, from a header about the current picture or SPS.

Also, the image data and encoding information extractor 220 extracts information about a coded depth and an encoding mode for the coding units having a tree structure according to each maximum coding unit, from the parsed bitstream. The extracted information about the coded depth and the encoding mode is output to the image data decoder 230. In other words, the image data in a bit stream is split into the maximum coding unit so that the image data decoder 230 decodes the image data for each maximum coding unit.

The information about the coded depth and the encoding mode according to the maximum coding unit may be set for information about at least one coding unit corresponding to the coded depth, and information about an encoding mode may include information about a partition type of a corresponding coding unit corresponding to the coded depth, about a prediction mode, and a size of a transformation unit. Also, split information according to depths may be extracted as the information about the coding depth.

The information about the coded depth and the encoding mode according to each maximum coding unit extracted by the image data and encoding information extractor 220 is information about a coded depth and an encoding mode determined to generate a minimum encoding error when an encoder, such as the video encoding apparatus 100, repeatedly performs encoding for each deeper coding unit according to depths according to each maximum coding unit. Accordingly, the video decoding apparatus 200 may restore an image by decoding the image data according to a coded depth and an encoding mode that generates the minimum encoding error.

Since encoding information about the coded depth and the encoding mode may be assigned to a predetermined data unit from among a corresponding coding unit, a prediction unit, and a minimum unit, the image data and encoding information extractor 220 may extract the information about the coded depth and the encoding mode according to the predetermined data units. The predetermined data units to which the same information about the coded depth and the encoding mode is assigned may be inferred to be the data units included in the same maximum coding unit.

The image data decoder 230 restores the current picture by decoding the image data in each maximum coding unit based on the information about the coded depth and the encoding mode according to the maximum coding units. In other words, the image data decoder 230 may decode the encoded image data based on the extracted information about the partition type, the prediction mode, and the transformation unit for each coding unit from among the coding units having the tree structure included in each maximum coding unit. A decoding process may include a prediction including intra prediction and motion compensation, and an inverse transformation.

The image data decoder 230 may perform intra prediction or motion compensation according to a partition and a prediction mode of each coding unit, based on the information about the partition type and the prediction mode of the prediction unit of the coding unit according to coded depths.

Also, the image data decoder 230 may perform inverse transformation based on a transformation unit in units of a coding unit, based on the information about the size of the transformation unit of the coding unit according to coded depths, so as to perform the inverse transformation according to maximum coding units.

The image data decoder 230 may determine at least one coded depth of a current maximum coding unit by using split information according to depths. If the split information indicates that image data is no longer split in the current depth, the current depth is a coded depth. Accordingly, the image data decoder 230 may decode encoded data of at least one coding unit corresponding to the each coded depth in the current maximum coding unit by using the information about the partition type of the prediction unit, the prediction mode, and the size of the transformation unit for each coding unit corresponding to the coded depth, and output the image data of the current maximum coding unit.

In other words, data units containing the encoding information including the same split information may be gathered by observing the encoding information set assigned for the predetermined data unit from among the coding unit, the prediction unit, and the minimum unit, and the gathered data units may be considered to be one data unit to be decoded by the image data decoder 230 in the same encoding mode.

The video decoding apparatus 200 may obtain encoding information about at least one coding unit that generates the minimum encoding error when encoding is recursively performed for each maximum coding unit, and may use the information to decode the current picture. In other words, the coding units having the tree structure determined to be the optimum coding units in each maximum coding unit may be decoded.

Accordingly, the video decoding apparatus 200 may efficiently decode even image data corresponding to an image having a high resolution or an excessively large amount of data according to the size and encoding mode of a coding unit adaptively determined according to the characteristics of the image, by using information about the optimal encoding mode received from the encoder.

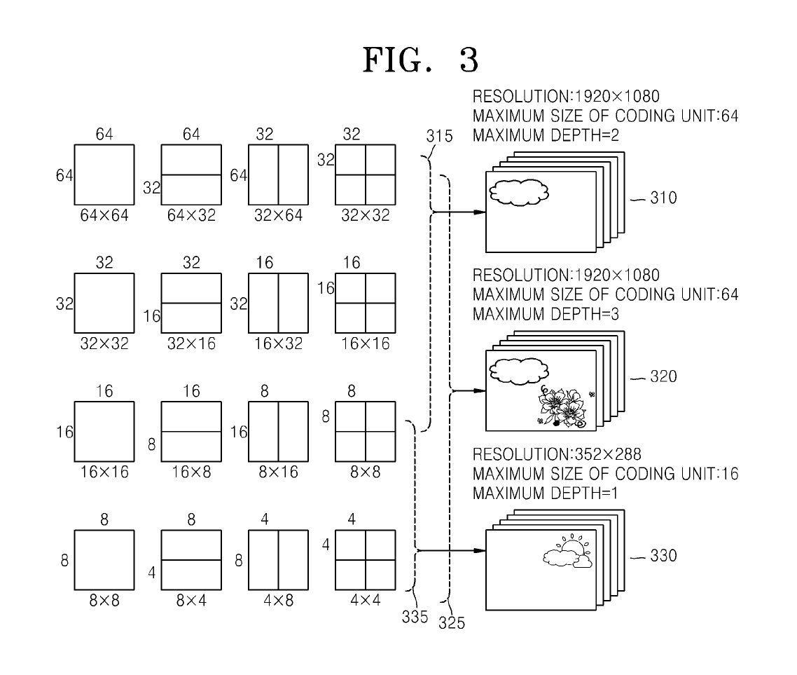

A method of determining coding units having a tree structure, a prediction unit, and a transformation unit, according to an exemplary embodiment, will now be described with reference to FIGS. 3 through 13.

FIG. 3 is a diagram for describing a concept of hierarchical coding units according to an exemplary embodiment.

A size of a coding unit may be expressed in width×height, and may be 64×64, 32×32, 16×16, and 8×8. A coding unit of 64×64 may be split into partitions of 64×64, 64×32, 32×64, or 32×32, and a coding unit of 32×32 may be split into partitions of 32×32, 32×16, 16×32, or 16×16, a coding unit of 16×16 may be split into partitions of 16×16, 16×8, 8×16, or 8×8, and a coding unit of 8×8 may be split into partitions of 8×8, 8×4, 4×8, or 4×4.

In video data 310, a resolution is 1920×1080, a maximum size of a coding unit is 64, and a maximum depth is 2. In video data 320, a resolution is 1920×1080, a maximum size of a coding unit is 64, and a maximum depth is 3. In video data 330, a resolution is 352×288, a maximum size of a coding unit is 16, and a maximum depth is 1. The maximum depth of FIG. 3 denotes a total number of splits from a maximum coding unit to a minimum decoding unit.

If a resolution is high or a data amount is large, a maximum size of a coding unit may be large so as to not only increase encoding efficiency but also to accurately reflect characteristics of an image. Accordingly, the maximum size of the coding unit of the video data 310 and 320 having the higher resolution than the video data 330 may be 64.

Since the maximum depth of the video data 310 is 2, coding units 315 of the vide data 310 may include a maximum coding unit having a long axis size of 64, and coding units having long axis sizes of 32 and 16 since depths are deepened to two layers by splitting the maximum coding unit twice. Meanwhile, since the maximum depth of the video data 330 is 1, coding units 335 of the video data 330 may include a maximum coding unit having a long axis size of 16, and coding units having a long axis size of 8 since depths are deepened to one layer by splitting the maximum coding unit once.

Since the maximum depth of the video data 320 is 3, coding units 325 of the video data 320 may include a maximum coding unit having a long axis size of 64, and coding units having long axis sizes of 32, 16, and 8 since the depths are deepened to 3 layers by splitting the maximum coding unit three times. As a depth deepens, detailed information may be precisely expressed.

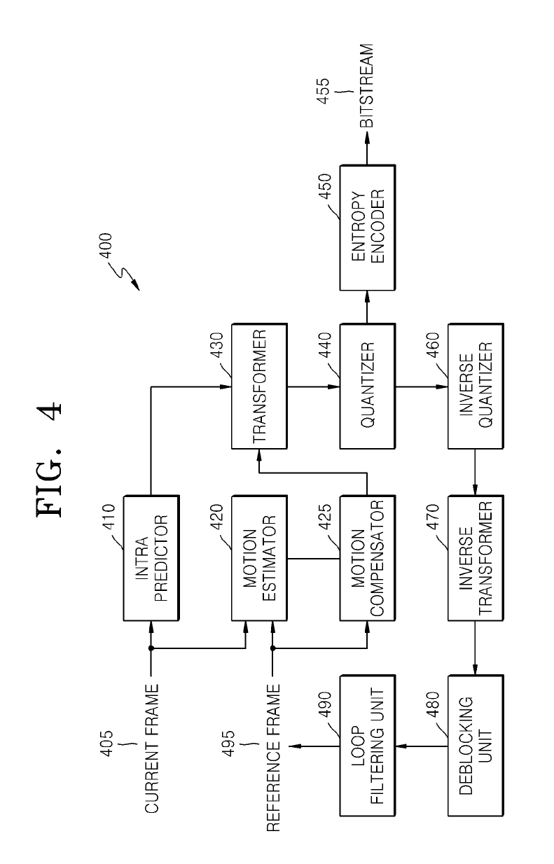

FIG. 4 is a block diagram of an image encoder 400 based on coding units, according to an exemplary embodiment.

The image encoder 400 performs operations of the coding unit determiner 120 of the video encoding apparatus 100 to encode image data. In other words, an intra predictor 410 performs intra prediction on coding units in an intra mode, from among a current frame 405, and a motion estimator 420 and a motion compensator 425 performs inter estimation and motion compensation on coding units in an inter mode from among the current frame 405 by using the current frame 405, and a reference frame 495.

Data output from the intra predictor 410, the motion estimator 420, and the motion compensator 425 is output as a quantized transformation coefficient through a transformer 430 and a quantizer 440. The quantized transformation coefficient is restored as data in a spatial domain through an inverse quantizer 460 and an inverse transformer 470, and the restored data in the spatial domain is output as the reference frame 495 after being post-processed through a deblocking unit 480 and a loop filtering unit 490. The quantized transformation coefficient may be output as a bitstream 455 through an entropy encoder 450.

In order for the image encoder 400 to be applied in the video encoding apparatus 100, all elements of the image encoder 400, i.e., the intra predictor 410, the motion estimator 420, the motion compensator 425, the transformer 430, the quantizer 440, the entropy encoder 450, the inverse quantizer 460, the inverse transformer 470, the deblocking unit 480, and the loop filtering unit 490 perform operations based on each coding unit from among coding units having a tree structure while considering the maximum depth of each maximum coding unit.

Specifically, the intra predictor 410, the motion estimator 420, and the motion compensator 425 determines partitions and a prediction mode of each coding unit from among the coding units having a tree structure while considering the maximum size and the maximum depth of a current maximum coding unit, and the transformer 430 determines the size of the transformation unit in each coding unit from among the coding units having a tree structure.

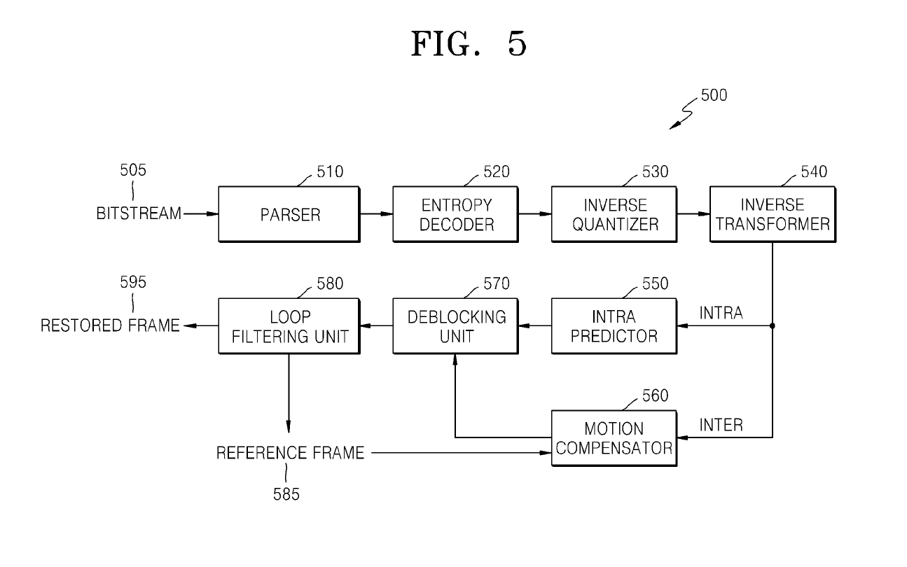

FIG. 5 is a block diagram of an image decoder 500 based on coding units, according to an exemplary embodiment.

A parser 510 parses encoded image data to be decoded and information about encoding required for decoding from a bitstream 505. The encoded image data is output as inverse quantized data through an entropy decoder 520 and an inverse quantizer 530, and the inverse quantized data is restored to image data in a spatial domain through an inverse transformer 540.

An intra predictor 550 performs intra prediction on coding units in an intra mode with respect to the image data in the spatial domain, and a motion compensator 560 performs motion compensation on coding units in an inter mode by using a reference frame 585.

The image data in the spatial domain, which passed through the intra predictor 550 and the motion compensator 560, may be output as a restored frame 595 after being post-processed through a deblocking unit 570 and a loop filtering unit 580. Also, the image data that is post-processed through the deblocking unit 570 and the loop filtering unit 580 may be output as the reference frame 585.

In order to decode the image data in the image data decoder 230 of the video decoding apparatus 200, the image decoder 500 may perform operations that are performed after the parser 510.

In order for the image decoder 500 to be applied in the video decoding apparatus 200, all elements of the image decoder 500, i.e., the parser 510, the entropy decoder 520, the inverse quantizer 530, the inverse transformer 540, the intra predictor 550, the motion compensator 560, the deblocking unit 570, and the loop filtering unit 580 perform operations based on coding units having a tree structure for each maximum coding unit.

Specifically, the intra prediction 550 and the motion compensator 560 perform operations based on partitions and a prediction mode for each of the coding units having a tree structure, and the inverse transformer 540 perform operations based on a size of a transformation unit for each coding unit.

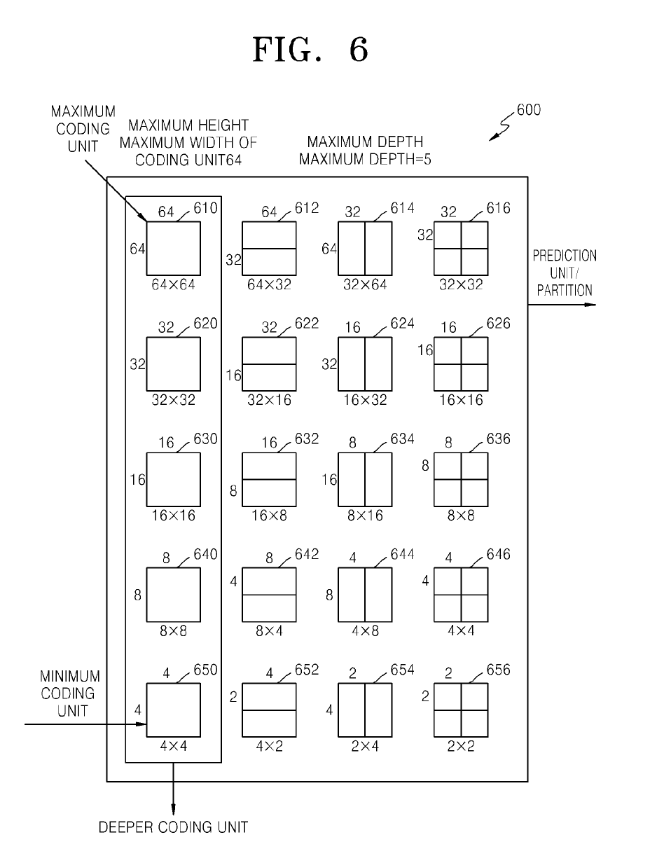

FIG. 6 is a diagram illustrating deeper coding units according to depths, and partitions, according to an exemplary embodiment.

The video encoding apparatus 100 and the video decoding apparatus 200 use hierarchical coding units so as to consider characteristics of an image. A maximum height, a maximum width, and a maximum depth of coding units may be adaptively determined according to the characteristics of the image, or may be differently set by a user. Sizes of deeper coding units according to depths may be determined according to the predetermined maximum size of the coding unit.

In a hierarchical structure 600 of coding units, according to an exemplary embodiment, the maximum height and the maximum width of the coding units are each 64, and the maximum depth is 4. Since a depth deepens along a vertical axis of the hierarchical structure 600, a height and a width of the deeper coding unit are each split. Also, a prediction unit and partitions, which are bases for prediction encoding of each deeper coding unit, are shown along a horizontal axis of the hierarchical structure 600.

In other words, a coding unit 610 is a maximum coding unit in the hierarchical structure 600, wherein a depth is 0 and a size, i.e., a height by width, is 64×64. The depth deepens along the vertical axis, and a coding unit 620 having a size of 32×32 and a depth of 1, a coding unit 630 having a size of 16×16 and a depth of 2, a coding unit 640 having a size of 8×8 and a depth of 3, and a coding unit 650 having a size of 4×4 and a depth of 4 exist. The coding unit 650 having the size of 4×4 and the depth of 4 is a minimum coding unit.

The prediction unit and the partitions of a coding unit are arranged along the horizontal axis according to each depth. In other words, if the coding unit 610 having the size of 64×64 and the depth of 0 is a prediction unit, the prediction unit may be split into partitions included in the coding unit 610, i.e., a partition 610 having a size of 64×64, partitions 612 having the size of 64×32, partitions 614 having the size of 32×64, or partitions 616 having the size of 32×32.

Similarly, a prediction unit of the coding unit 620 having the size of 32×32 and the depth of 1 may be split into partitions included in the coding unit 620, i.e., a partition 620 having a size of 32×32, partitions 622 having a size of 32×16, partitions 624 having a size of 16×32, and partitions 626 having a size of 16×16.

Similarly, a prediction unit of the coding unit 630 having the size of 16×16 and the depth of 2 may be split into partitions included in the coding unit 630, i.e., a partition having a size of 16×16 included in the coding unit 630, partitions 632 having a size of 16×8, partitions 634 having a size of 8×16, and partitions 636 having a size of 8×8.

Similarly, a prediction unit of the coding unit 640 having the size of 8×8 and the depth of 3 may be split into partitions included in the coding unit 640, i.e., a partition having a size of 8×8 included in the coding unit 640, partitions 642 having a size of 8×4, partitions 644 having a size of 4×8, and partitions 646 having a size of 4×4.

The coding unit 650 having the size of 4×4 and the depth of 4 is the minimum coding unit and a coding unit of the lowermost depth. A prediction unit of the coding unit 650 is only assigned to a partition having a size of 4×4.

In order to determine the at least one coded depth of the coding units constituting the maximum coding unit 610, the coding unit determiner 120 of the video encoding apparatus 100 performs encoding for coding units corresponding to each depth included in the maximum coding unit 610.

A number of deeper coding units according to depths including data in the same range and the same size increases as the depth deepens. For example, four coding units corresponding to a depth of 2 are required to cover data that is included in one coding unit corresponding to a depth of 1. Accordingly, in order to compare encoding results of the same data according to depths, the coding unit corresponding to the depth of 1 and four coding units corresponding to the depth of 2 are each encoded.

In order to perform encoding for a current depth from among the depths, a least encoding error may be selected for the current depth by performing encoding for each prediction unit in the coding units corresponding to the current depth, along the horizontal axis of the hierarchical structure 600. Alternatively, the minimum encoding error may be searched for by comparing the least encoding errors according to depths, by performing encoding for each depth as the depth deepens along the vertical axis of the hierarchical structure 600. A depth and a partition having the minimum encoding error in the coding unit 610 may be selected as the coded depth and a partition type of the coding unit 610.

FIG. 7 is a diagram for describing a relationship between a coding unit 710 and transformation units 720, according to an exemplary embodiment.

The video encoding apparatus 100 or 200 encodes or decodes an image according to coding units having sizes smaller than or equal to a maximum coding unit for each maximum coding unit. Sizes of transformation units for transformation during encoding may be selected based on data units that are not larger than a corresponding coding unit.

For example, in the video encoding apparatus 100 or 200, if a size of the coding unit 710 is 64×64, transformation may be performed by using the transformation units 720 having a size of 32×32.

Also, data of the coding unit 710 having the size of 64×64 may be encoded by performing the transformation on each of the transformation units having the size of 32×32, 16×16, 8×8, and 4×4, which are smaller than 64×64, and then a transformation unit having the least coding error may be selected.

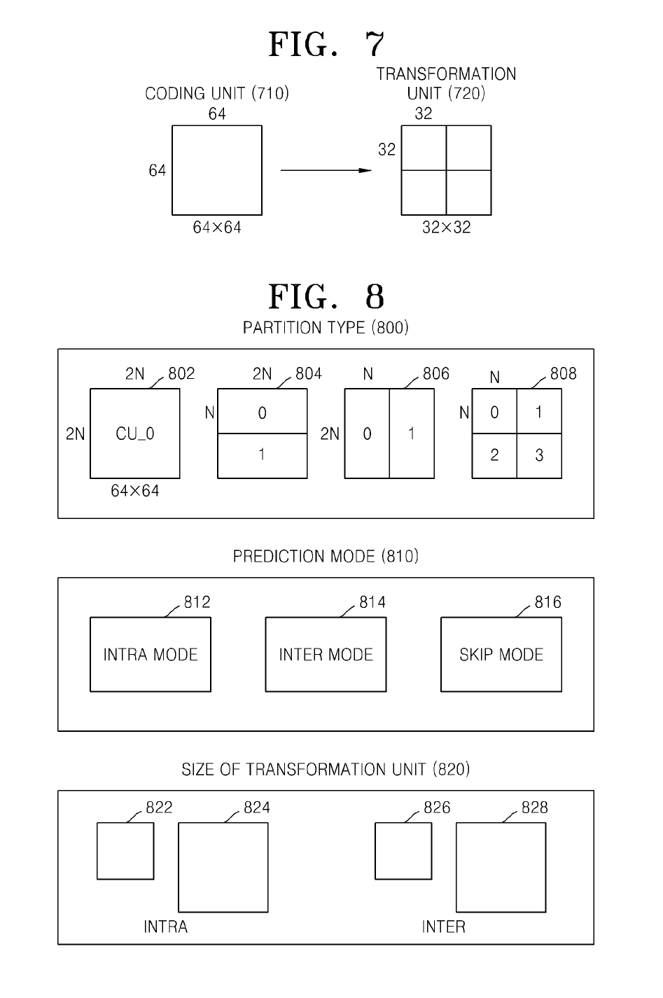

FIG. 8 is a diagram for describing encoding information of coding units corresponding to a coded depth, according to an exemplary embodiment.

The output unit 130 of the video encoding apparatus 100 may encode and transmit information 800 about a partition type, information 810 about a prediction mode, and information 820 about a size of a transformation unit for each coding unit corresponding to a coded depth, as information about an encoding mode.

The information 800 indicates information about a shape of a partition obtained by splitting a prediction unit of a current coding unit, wherein the partition is a data unit for prediction encoding the current coding unit. For example, a current coding unit CU_{—}0 having a size of 2N×2N may be split into any one of a partition 802 having a size of 2N×2N, a partition 804 having a size of 2N×N, a partition 806 having a size of N×2N, and a partition 808 having a size of N×N. Here, the information 800 about a partition type is set to indicate one of the partition 804 having a size of 2N×N, the partition 806 having a size of N×2N, and the partition 808 having a size of N×N

The information 810 indicates a prediction mode of each partition. For example, the information 810 may indicate a mode of prediction encoding performed on a partition indicated by the information 800, i.e., an intra mode 812, an inter mode 814, or a skip mode 816.

The information 820 indicates a transformation unit to be based on when transformation is performed on a current coding unit. For example, the transformation unit may be a first intra transformation unit 822, a second intra transformation unit 824, a first inter transformation unit 826, or a second intra transformation unit 828.

The image data and encoding information extractor 220 of the video decoding apparatus 200 may extract and use the information 800, 810, and 820 for decoding, according to each deeper coding unit.

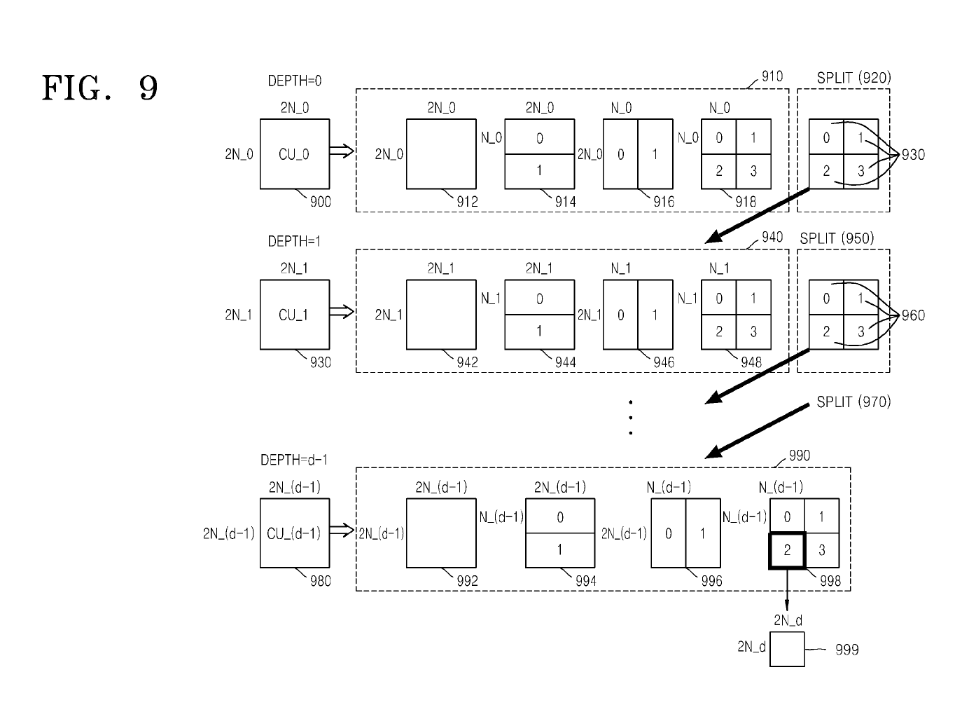

FIG. 9 is a diagram of deeper coding units according to depths, according to an exemplary embodiment.

Split information may be used to indicate a change of a depth. The spilt information indicates whether a coding unit of a current depth is split into coding units of a lower depth.

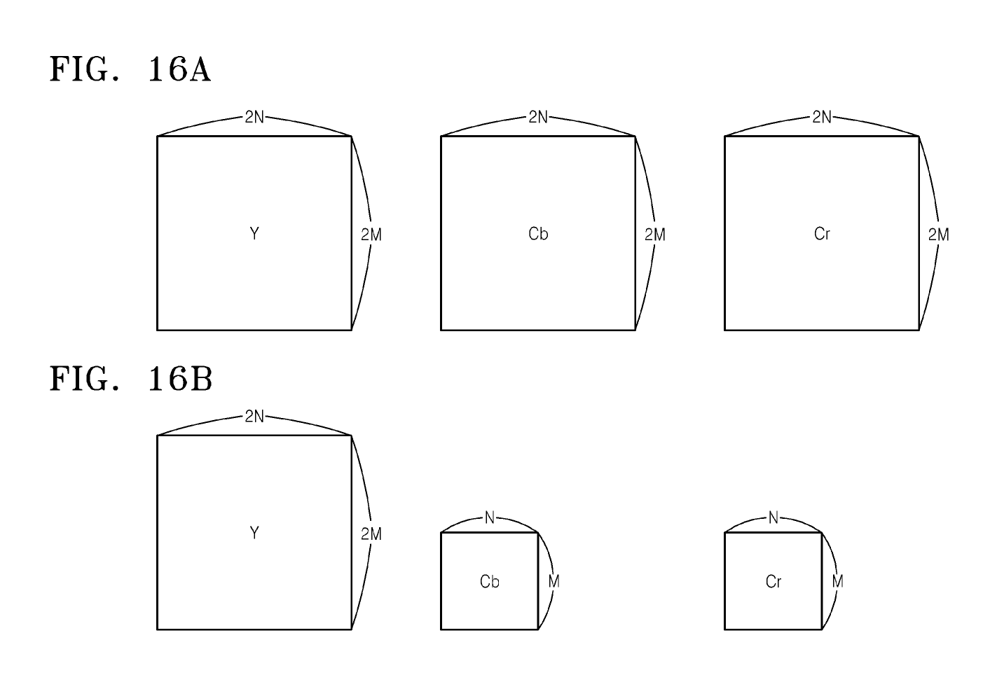

A prediction unit 910 for prediction encoding a coding unit 900 having a depth of 0 and a size of 2N_{—}0×2N_{—}0 may include partitions of a partition type 912 having a size of 2N_{—}0×2N_{—}0, a partition type 914 having a size of 2N_{—}0×N_{—}0, a partition type 916 having a size of N_{—}0×2N_{—}0, and a partition type 918 having a size of N_{—}0×N_{—}0. FIG. 16 only illustrates the partition types 912 through 918 which are obtained by symmetrically splitting the prediction unit 910, but a partition type is not limited thereto, and the partitions of the prediction unit 910 may include asymmetrical partitions, partitions having a predetermined shape, and partitions having a geometrical shape.

Prediction encoding is repeatedly performed on one partition having a size of 2N_{—}0×2N_{—}0, two partitions having a size of 2N_{—}0×N_{—}0, two partitions having a size of N_{—}0×2N_{—}0, and four partitions having a size of N_{—}0×N_{—}0, according to each partition type. The prediction encoding in an intra mode and an inter mode may be performed on the partitions having the sizes of 2N_{—}0×2N_{—}0, N_{—}0×2N_{—}0, 2N_{—}0×0, and N_{—}0×N_{—}0. The prediction encoding in a skip mode is performed only on the partition having the size of 2N_{—}02N_{—}0.

Errors of encoding including the prediction encoding in the partition types 912 through 918 are compared, and the least encoding error is determined among the partition types. If an encoding error is smallest in one of the partition types 912 through 916, the prediction unit 910 may not be split into a lower depth.

If the encoding error is the smallest in the partition type 918, a depth is changed from 0 to 1 to split the partition type 918 in operation 920, and encoding is repeatedly performed on coding units 930 having a depth of 2 and a size of N_{—}0×N_{—}0 to search for a minimum encoding error.

A prediction unit 940 for prediction encoding the coding unit 930 having a depth of 1 and a size of 2N_{—}1×2N_{—}1 (=N_{—}0×N_{—}0) may include partitions of a partition type 942 having a size of 2N_{—}1×2N_{—}1, a partition type 944 having a size of 2N_{—}1×N_{—}1, a partition type 946 having a size of N_{—}1×2N_{—}1, and a partition type 948 having a size of N_{—}1×N_{—}1.

If an encoding error is the smallest in the partition type 948, a depth is changed from 1 to 2 to split the partition type 948 in operation 950, and encoding is repeatedly performed on coding units 960, which have a depth of 2 and a size of N_{—}2×N_{—}2 to search for a minimum encoding error.

When a maximum depth is d, split operations according to each depth may be performed up to when a depth becomes d−1, and split information may be encoded as up to when a depth is one of 0 to d−2. In other words, when encoding is performed up to when the depth is d−1 after a coding unit corresponding to a depth of d−2 is split in operation 970, a prediction unit 990 for prediction encoding a coding unit 980 having a depth of d−1 and a size of 2N_(d−1)×2N_(d−1) may include partitions of a partition type 992 having a size of 2N_(d−1)×2N_(d−1), a partition type 994 having a size of 2N_(d−1)×N_(d−1), a partition type 996 having a size of N (d−1)×2N_(d−1), and a partition type 998 having a size of N_(d−1)×N_(d−1).

Prediction encoding may be repeatedly performed on one partition having a size of 2N_(d−1)×2N_(d−1), two partitions having a size of 2N_(d−1)×N_(d−1), two partitions having a size of N_(d−1)×2N_(d−1), four partitions having a size of N_(d−1)×N_(d−1) from among the partition types 992 through 998 to search for a partition type having a minimum encoding error.

Even when the partition type 998 has the minimum encoding error, since a maximum depth is d, a coding unit CU_(d−1) having a depth of d−1 is no longer split to a lower depth, and a coded depth for the coding units constituting a current maximum coding unit 900 is determined to be d−1 and a partition type of the current maximum coding unit 900 may be determined to be N_(d−1)×N_(d−1). Also, since the maximum depth is d and a minimum coding unit 980 having a lowermost depth of d−1 is no longer split to a lower depth, split information for the minimum coding unit 980 is not set.

A data unit 999 may be a ‘minimum unit’ for the current maximum coding unit. A minimum unit according to an exemplary embodiment may be a rectangular data unit obtained by splitting a minimum coding unit 980 by 4. By performing the encoding repeatedly, the video encoding apparatus 100 may select a depth having the least encoding error by comparing encoding errors according to depths of the coding unit 900 to determine a coded depth, and set a corresponding partition type and a prediction mode as an encoding mode of the coded depth.

As such, the minimum encoding errors according to depths are compared in all of the depths of 1 through d, and a depth having the least encoding error may be determined as a coded depth. The coded depth, the partition type of the prediction unit, and the prediction mode may be encoded and transmitted as information about an encoding mode. Also, since a coding unit is split from a depth of 0 to a coded depth, only split information of the coded depth is set to 0, and split information of depths excluding the coded depth is set to 1.

The image data and encoding information extractor 220 of the video decoding apparatus 200 may extract and use the information about the coded depth and the prediction unit of the coding unit 900 to decode the partition 912. The video decoding apparatus 200 may determine a depth, in which split information is 0, as a coded depth by using split information according to depths, and use information about an encoding mode of the corresponding depth for decoding.

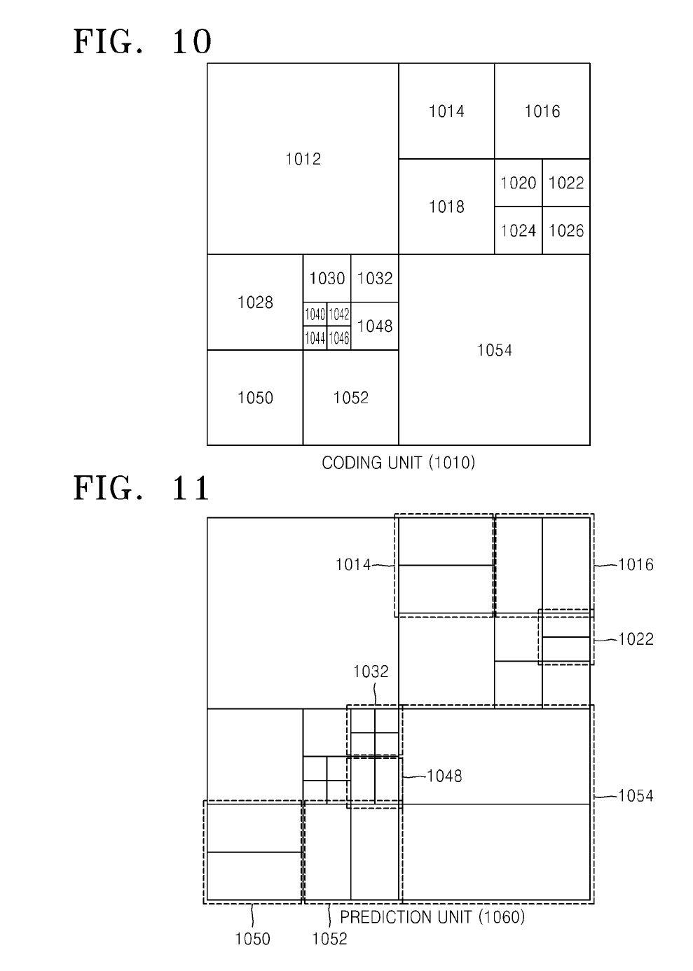

FIGS. 10, 11, and 12 are diagrams for describing a relationship between coding units 1010, prediction units 1060, and transformation units 1070, according to an exemplary embodiment.

The coding units 1010 are coding units having a tree structure, corresponding to coded depths determined by the video encoding apparatus 100, in a maximum coding unit. The prediction units 1060 are partitions of prediction units of each of the coding units 1010, and the transformation units 1070 are transformation units of each of the coding units 1010.

When a depth of a maximum coding unit is 0 in the coding units 1010, depths of coding units 1012 and 1054 are 1, depths of coding units 1014, 1016, 1018, 1028, 1050, and 1052 are 2, depths of coding units 1020, 1022, 1024, 1026, 1030, 1032, and 1048 are 3, and depths of coding units 1040, 1042, 1044, and 1046 are 4.

In the prediction units 1060, some encoding units 1014, 1016, 1022, 1032, 1048, 1050, 1052, and 1054 are obtained by splitting the coding units in the encoding units 1010. In other words, partition types in the coding units 1014, 1022, 1050, and 1054 have a size of 2N×N, partition types in the coding units 1016, 1048, and 1052 have a size of N×2N, and a partition type of the coding unit 1032 has a size of N×N. Prediction units and partitions of the coding units 1010 are smaller than or equal to each coding unit.

Transformation or inverse transformation is performed on image data of the coding unit 1052 in the transformation units 1070 in a data unit that is smaller than the coding unit 1052. Also, the coding units 1014, 1016, 1022, 1032, 1048, 1050, and 1052 in the transformation units 1070 are different from those in the prediction units 1060 in terms of sizes and shapes. In other words, the video encoding and decoding apparatuses 100 and 200 may perform intra prediction, motion estimation, motion compensation, transformation, and inverse transformation individually on a data unit in the same coding unit.

Accordingly, encoding is recursively performed on each of coding units having a hierarchical structure in each region of a maximum coding unit to determine an optimum coding unit, and thus coding units having a recursive tree structure may be obtained. Encoding information may include split information about a coding unit, information about a partition type, information about a prediction mode, and information about a size of a transformation unit. Table 1 shows the encoding information that may be set by the video encoding and decoding apparatuses 100 and 200.

TABLE 1

| Split Information 0 | | | | | |
|---|---|---|---|---|---|
| (Encoding on Coding Unit having Size | | | | | |
| of 2N × 2N and Current Depth of d) | | | | | |
| | | | Size of Transformation Unit | | |
| | | | Split | Split | |
| | Partition Type | | Information 0 | Information 1 | |
| | Symmetrical | Asymmetrical | of | of | |
| Prediction | Partition | Partition | Transformation | Transformation | Split |
| Mode | Type | Type | Unit | Unit | Information 1 |
| Intra | 2N × 2N | 2N × nU | 2N × 2N | N × N | Repeatedly |
| Inter | 2N × N | 2N × nD | | (Symmetrical | Encode |
| Skip | N × 2N | nL × 2N | | Type) | Coding Units |
| (Only | N × N | nR × 2N | | N/2 × N/2 | having |
| 2N × 2N) | | | | (Asymmetrical | Lower Depth |
| | | | | Type) | of d + 1 |

The output unit 130 of the video encoding apparatus 100 may output the encoding information about the coding units having a tree structure, and the image data and encoding information extractor 220 of the video decoding apparatus 200 may extract the encoding information about the coding units having a tree structure from a received bitstream.

Split information indicates whether a current coding unit is split into coding units of a lower depth. If split information of a current depth d is 0, a depth, in which a current coding unit is no longer split into a lower depth, is a coded depth, and thus information about a partition type, prediction mode, and a size of a transformation unit may be defined for the coded depth. If the current coding unit is further split according to the split information, encoding is independently performed on four split coding units of a lower depth.

A prediction mode may be one of an intra mode, an inter mode, and a skip mode. The intra mode and the inter mode may be defined in all partition types, and the skip mode is defined only in a partition type having a size of 2N×2N.

The information about the partition type may indicate symmetrical partition types having sizes of 2N×2N, 2N×N, N×2N, and N×N, which are obtained by symmetrically splitting a height or a width of a prediction unit, and asymmetrical partition types having sizes of 2N×nU, 2N×nD, nL×2N, and nR×2N, which are obtained by asymmetrically splitting the height or width of the prediction unit. The asymmetrical partition types having the sizes of 2N×nU and 2N×nD may be respectively obtained by splitting the height of the prediction unit in 1:3 and 3:1, and the asymmetrical partition types having the sizes of nL×2N and nR×2N may be respectively obtained by splitting the width of the prediction unit in 1:3 and 3:1

The size of the transformation unit may be set to be two types in the intra mode and two types in the inter mode. In other words, if split information of the transformation unit is 0, the size of the transformation unit may be 2N×2N, which is the size of the current coding unit. If split information of the transformation unit is 1, the transformation units may be obtained by splitting the current coding unit. Also, if a partition type of the current coding unit having the size of 2N×2N is a symmetrical partition type, a size of a transformation unit may be N×N, and if the partition type of the current coding unit is an asymmetrical partition type, the size of the transformation unit may be N/2×N/2.

The encoding information about coding units having a tree structure may include at least one of a coding unit corresponding to a coded depth, a prediction unit, and a minimum unit. The coding unit corresponding to the coded depth may include at least one of a prediction unit and a minimum unit containing the same encoding information.

Accordingly, it is determined whether adjacent data units are included in the same coding unit corresponding to the coded depth by comparing encoding information of the adjacent data units. Also, a corresponding coding unit corresponding to a coded depth is determined by using encoding information of a data unit, and thus a distribution of coded depths in a maximum coding unit may be determined.

Accordingly, if a current coding unit is predicted based on encoding information of adjacent data units, encoding information of data units in deeper coding units adjacent to the current coding unit may be directly referred to and used.

Alternatively, if a current coding unit is predicted based on encoding information of adjacent data units, data units adjacent to the current coding unit are searched using encoded information of the data units, and the searched adjacent coding units may be referred for predicting the current coding unit.

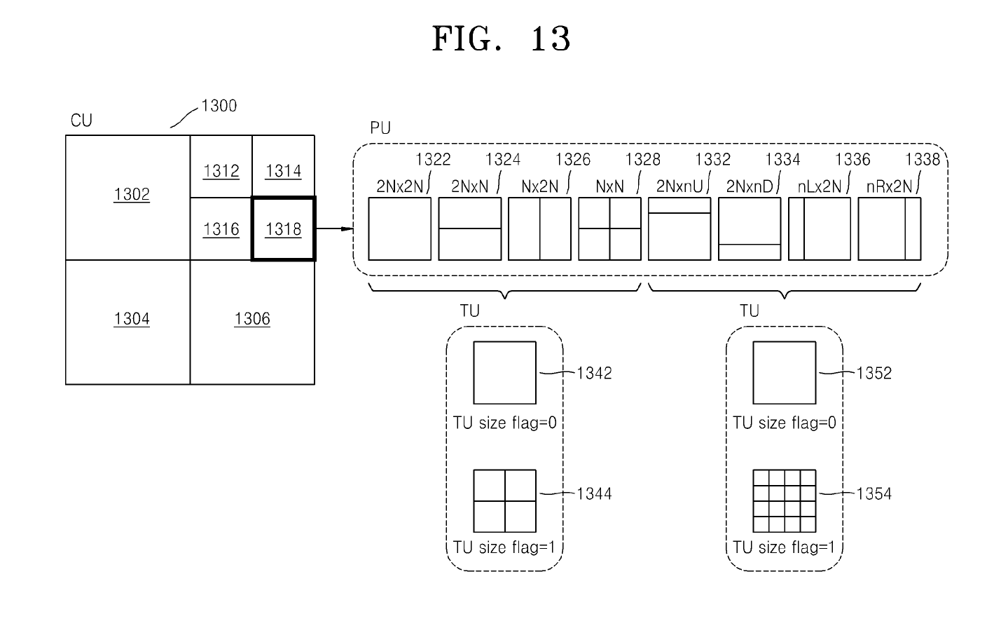

FIG. 13 is a diagram for describing a relationship between a coding unit, a prediction unit or a partition, and a transformation unit, according to encoding mode information of Table 1.

A maximum coding unit 1300 includes coding units 1302, 1304, 1306, 1312, 1314, 1316, and 1318 of coded depths. Here, since the coding unit 1318 is a coding unit of a coded depth, split information may be set to 0. Information about a partition type of the coding unit 1318 having a size of 2N×2N may be set to be one of a partition type 1322 having a size of 2N×2N, a partition type 1324 having a size of 2N×N, a partition type 1326 having a size of N×2N, a partition type 1328 having a size of N×N, a partition type 1332 having a size of 2N×nU, a partition type 1334 having a size of 2N×nD, a partition type 1336 having a size of nL×2N, and a partition type 1338 having a size of nR×2N.

When the partition type is set to be symmetrical, i.e., the partition type 1322, 1324, 1326, or 1328, a transformation unit 1342 having a size of 2N×2N is set if the TU size flag of a transformation unit is 0, and a transformation unit 1344 having a size of N×N is set if a TU size flag is 1.

When the partition type is set to be asymmetrical, i.e., the partition type 1332, 1334, 1336, or 1338, a transformation unit 1352 having a size of 2N×2N is set if a TU size flag is 0, and a transformation unit 1354 having a size of N/2×N/2 is set if a TU size flag is 1.

The prediction performed in the encoding apparatus 400 of FIG. 4 and the prediction performed in the decoding apparatus 400 of FIG. 5 will now be described in detail. A prediction process according to an exemplary embodiment may be performed as a new intra prediction mode by the intra predictor 410 of FIG. 4 and the intra predictor 550 of FIG. 5. Hereinafter, the prediction unit is referred to as a block.

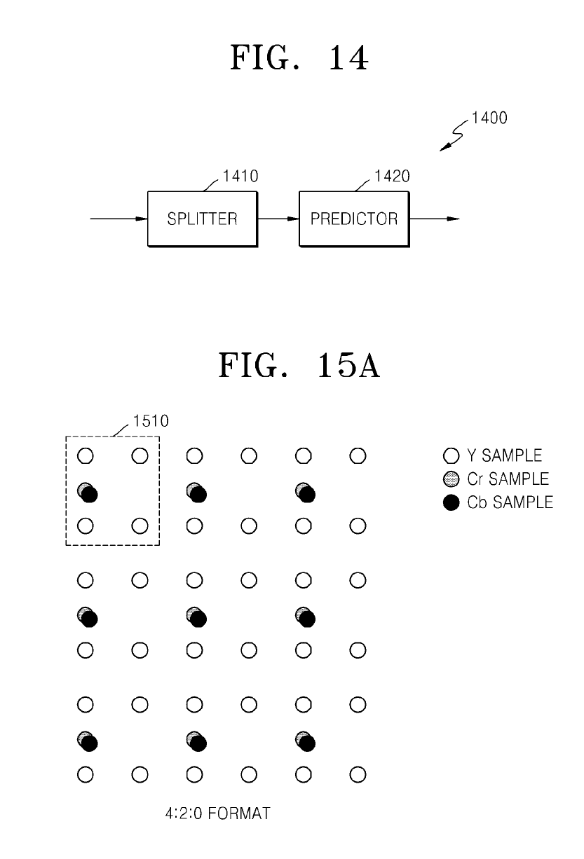

FIG. 14 is a block diagram of a video encoding apparatus 1400 for encoding a video signal including a plurality of color components, according to an exemplary embodiment.

Referring to FIG. 14, the video encoding apparatus 1400 includes a splitter 1410 and a predictor 1420.

The splitter 1410 receives a video signal including a plurality of color components and a video signal having a first color component restored after previously being encoded, and splits a first color component block and the neighboring pixels of the first color component block into N (where N is an integer) segments according to the pixel values of the pixels of the first color component block corresponding to a second color component block being currently encoded. The splitter 1410 splits the second color component block and the neighboring pixels of the second color component block into N segments according to the N segments of the first color component block and the neighboring pixels of the first color component block.

The predictor 1420 predicts each of the N segments of the second color component block by using the neighboring pixels of the second color component block split into the N segments.

In general, a color video signal uses at least three color components for each pixel in order to accurately represent a color. A method used to represent luminance and a color is explained using a color space. There are various color spaces such as an RGB color space representing each sample of a color video signal through three pixel values indicating a relative ratio of red, green, and blue, and a YCbCr color space independently representing a luminance component and a chrominance component of a color video signal in consideration of the fact that a Human Visual System (HVS) is more sensitive to luminance than to chrominance. In general video encoding/decoding methods, a video signal is divided into a plurality of color components, and encoding and decoding are performed on the color components.

There is a high possibility that a certain correlation exists among the color components of a video signal that represent an identical pixel. For example, there is a high possibility that the pixel values of a luminance component Y and chrominance components Cb and Cr that represent one pixel are similar to each other. Accordingly, the video encoding apparatus 1400 splits the first color component block and its neighboring pixels into N segments according to the pixel values of the first color component block restored after being previously encoded to use the correlation among the plurality of color components, splits another color component into N segments according to splitting information of the first color component block and its neighboring pixels, and then predicts a corresponding segment by using neighboring pixels belonging to an identical segment from among the neighboring pixels of the other color component block, thereby improving the accuracy of prediction. The splitting of color component blocks into N segments, which is performed by the splitter 1410, will now be described in detail. The below description will be made by focusing on a method of prediction-encoding and prediction-decoding a video signal including three color components Y, Cb, and Cr, in a color space. However, it is understood that one or more other exemplary embodiments are not limited to such a YCbCr color space, and it will be understood by one of ordinary skill in the art that another exemplary embodiment may be applied to other color spaces such as an RGB space.

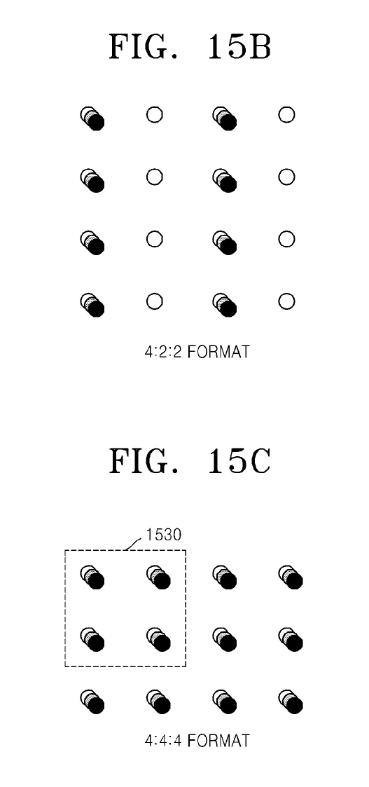

FIGS. 15A through 15C are reference diagrams illustrating color formats including a plurality of color components, according to an exemplary embodiment. FIGS. 16A and 16B are reference diagrams illustrating luminance blocks and chrominance blocks according to color formats, according to an exemplary embodiment.

In a 4:2:0 color format, a 4:2:2 color format, and a 4:4:4 color format of FIGS. 15A, 15B, and 15C, respectively, each numerical value indicates a relative sampling rate in a horizontal direction. For example, in the 4:4:4 color format, four Cb pixels and four Cr pixels exist for four Y pixels 1530. Referring to FIG. 16A, in the 4:4:4 color format, when the size of a Y luminance block is 2N×2M (where N and M are integers), Cb and Cr chrominance blocks corresponding to the Y luminance block each also have a 2N×2M size. In the 4:2:2 color format, the chrominance components Cb and Cr have a resolution equal to the resolution of the luminance component Y in a horizontal direction, but have a resolution half the resolution of the luminance component in a vertical direction. In other words, in the 4:2:2 color format, two Cb pixels and two Cr pixels exist for four luminance pixels 1510 in a horizontal direction. In the 4:2:0 color format, the chrominance components Cb and Cr have a resolution half the resolution of the luminance component Y in both vertical and horizontal directions. In other words, each of the chrominance components Cb and Cr has pixels, the number of which is ¼ the number of pixels of the luminance component Y, and, in the 4:2:0 format as illustrated in FIG. 16B, has a N×M size obtained by vertically and horizontally halving the 2N×2M size of the luminance block Y. A case where a video signal having a luminance component as a first color component and a chrominance component as a second color component in the 4:2:0 color format is prediction-encoded will be focused in the description of exemplary embodiments.

FIG. 17 is a reference diagram for illustrating splitting of a first color component block 1710 and its neighboring pixels 1720, which constitute a first color component, and splitting of a second color component block 1730 and a neighboring pixels 1740 by using the splitting of the first color component block 1710 and the neighboring pixels 1720, which constitute a second color component, according to an exemplary embodiment.

Referring to FIG. 17, the splitter 1410 splits the first color component block 1710 and the neighboring pixels 1720 of the first color component block 1710 into N segments, based on pixel values of the first color component block 1710 which have been previously encoded and restored. Although a case of N=2, that is, a case where the first color component block 1710 and the neighboring pixels 1720 are each split into two segments seg1 and seg2, will be described below, the number N of segments may be set to be greater than 2. The first color component block 1710 is one color component that constitutes a current picture encoded and restored before another color component by the encoding apparatus 400 of FIG. 4, and thus may be the luminance component Y when the current picture is expressed using a YCbCr color space.

In detail, the splitter 1410 may set (N−1) reference values based on the pixel values of the first color component block 1710 and split the first color component block 1710 and the neighboring pixels 1720 of the first color component block 1710 into N segments according to the (N−1) reference values. For example, when a pixel of the first color component is expressed as 8 bits, the pixel of the first color component may have values of 0 through 255. The range of the pixel values of 0 through 255 is split into N sections, the N sections are sequentially defined as Seg1, . . . , and SegN, and then the first color component block 1710 and the neighboring pixels 1720 of the first color component block 1710 are classified according to which sections the pixel values belong. In this way, the splitting may be performed.

For example, when N=2 and a mean value of the first color component block 1710 is used as a reference value, the splitter 1410 splits the first color component block 1710 and the neighboring pixels 1720 of the first color component block 1710 into the two segments Seg1 and Seg2 by classifying a pixel having a value less than or equal to the mean value into the segment Seg1, and a pixel having a value greater than the mean value into the segment Seg2. Although a case where the first color component block 1710 is split into two segments 1711 and 1712 and the neighboring pixels 1720 of the first color component block 1710 are classified into two segments 1721 and 1722 is illustrated in FIG. 17, the first color component block 1710 and the neighboring pixels 1720 may each be split into one segment or may be split by scattered Seg1 and Seg2 as shown in FIG. 19.

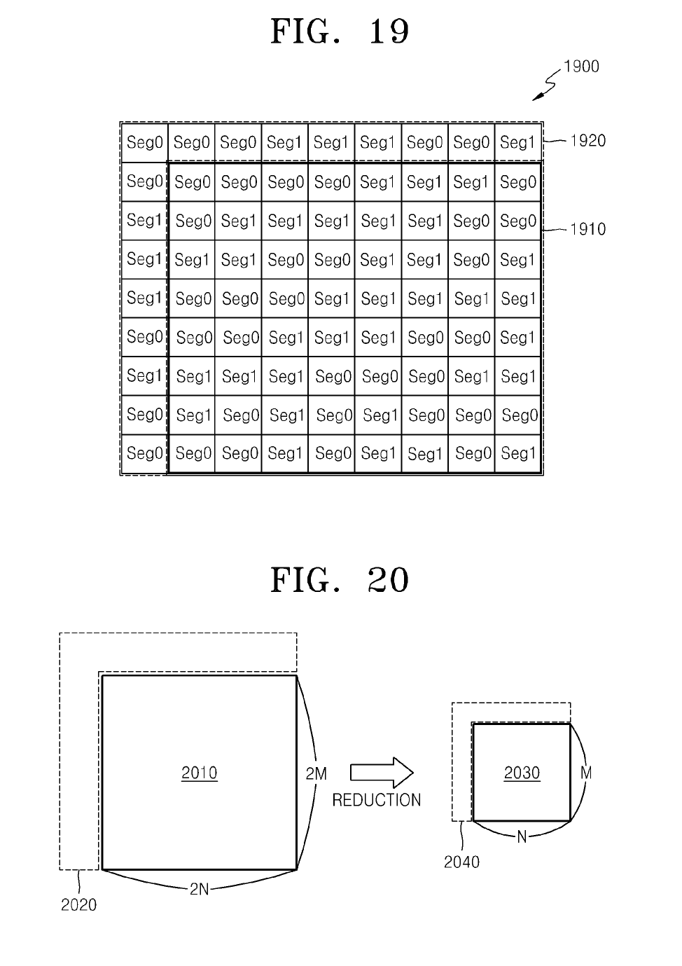

After completing the splitting of the first color component block 1710 and the neighboring pixels 1720, the splitter 1410 also splits the second color component block 1730 corresponding to the first color component block 1710 and the neighboring pixels 1740 of the second color component block 1730 by using information about the splitting of the first color component. The second color component may be the chrominance component Cb or Cr. When the 4:4:4 color format is used, a luminance block as the first color component block and a chrominance block as the second color component have the same size, and thus the splitter 1410 may split the second color component block and its neighboring pixels into segments like the splitting of the first color component block and its neighboring pixels by using information about the splitting of the first color component block and its neighboring pixels. However, when a luminance block and a chrominance block have different sizes as in the 4:2:2 or 4:2:0 color format, the splitter 1410 reduces the luminance block as the first color component and its neighboring pixel to the size of the chrominance block as the second color component instead of using the first color component block and its neighboring pixel as they are, and then performs the above-described splitting on the reduced luminance block and its reduced neighboring pixel, thereby splitting the first color component and its neighboring pixel into N segments. When the first color component block and the second color component block have different sizes, a process of splitting the first color component block, the second color component block, and their neighboring pixels will be described later with reference to FIG. 20.

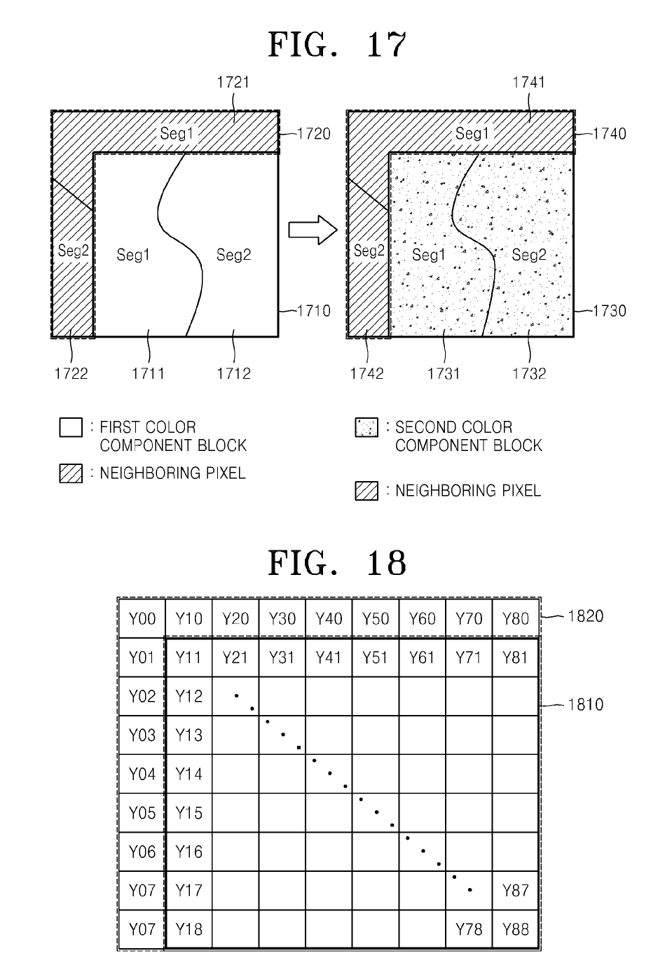

FIG. 18 is a reference diagram for illustrating a first color component block 1810 and its neighboring pixels 1820 according to an exemplary embodiment, and FIG. 19 is a reference diagram for illustrating segments into which a first color component block 1910 and its neighboring pixels 1920 are split, according to an exemplary embodiment.

Referring to FIG. 18, the splitter 1410 calculates a predetermined reference value based on the pixel values of the first color component block 1810. As in the above-described example, when the splitter 1410 uses a mean value as the reference value, a mean Mean of pixel values Yi,j of the first color component block 1810 is calculated using Equation 1 below:

$$Mean = round [ \frac{{\sum }_{i , j} {Y}_{ij}}{S} + 0.5 ] , \qquad [ Equation 1 ]$$

where i and j are integers ranging from 1 to 8, and S denotes the number of pixels included in the first color component block 1810 as a prediction unit, and may be written as a power of 2. For example, S may be a power of 2, such as 4, 8, 16, 32, 64, 128, 256, or the like. In this case, a division operation included in Equation 1 may be replaced by a shift operation, and thus the arithmetic operation of Equation 1 may be performed at an improved speed when being implemented into software or hardware.

When a mean value of the first color component block 1810 is calculated using Equation 1, the splitter 1410 splits the first color component block 1810 and its neighboring pixels 1820 into 2 segments by using the mean value, according to Equation 2 below:

S(i,j)=0, if Y(i,j)≦mean

S(i,j)=1, if Y(i,j)>mean [Equation 3]

where Y(i,j) indicates a pixel value of a first color component pixel at a location (i,j), and i and j are integers ranging from 0 to 8.

When a pixel having S(i,j) of 0 is defined as a segment Seg0 and a pixel having S(i,j) of 1 is defined as a segment Seg1, the first color component block 1910 and the neighboring pixels 1920 are divided and classified into the two segment Seg0 or Seg1 as illustrated in FIG. 19.

As described above, after completing the splitting of the first color component block 1910 and the neighboring pixels 1920, the splitter 1410 splits a second color component block corresponding to the first color component block 1910 and a neighboring block of the second color component block into the same segments as those into which the first color component 1910 and the neighboring pixels 1920 are split.

The splitter 1410 may additionally perform a re-classifying process of more finely adjusting the first color component split through Equation 2. In detail, the splitter 1410 may calculate respective mean values of the N segments and then re-classify the pixels of a first color component block and its neighboring pixels so that the pixels of the first color component block and its neighboring pixels are included in a segment having the most similar mean value among the N segments. For example, referring to FIG. 19, when a mean value of pixels of the first color component block 1910 classified into the segment Seg0 is defined as Mean0 and a mean value of pixels of the first color component block 1910 classified into the segment Seg1 is defined as Mean1, the splitter 1410 may re-classify the first color component block 1910 and the neighboring pixels 1920 by using Equation 3 below:

S(i,j)=0, if |Y(i,j)−mean0|≦|Y(i,j)−mean1|S(i,j)=1, otherwise [Equation 3]

where i and j are integers ranging from 0 to 8.

Referring to Equation 3, the splitter 1410 re-classifies the first color component block and its neighboring pixels by using a mean of the segments obtained by the primary splitting using Equation 2 so that pixels having similar pixel values are included in an identical segment, thereby improving the accuracy of splitting. The re-classifying process as in Equation 3 may be repeated several times.

When a luminance block and a chrominance block have an identical size as in the 4:4:4 color format, information about the splitting of the first color component block and its neighboring pixels may be applied to the second color component block without changes. On the other hand, when a luminance block and a chrominance block have different sizes as in the 4:2:2 or 4:2:0 color format, the splitter 1410 reduces the luminance block and its neighboring pixels as the first color component to the size of the chrominance block as the second color component instead of using the first color component block and its neighboring pixels as they are, and then performs the above-described splitting on the reduced luminance block and the reduced neighboring pixels, thereby splitting the first color component and its neighboring pixels into N segments.

FIG. 20 is a reference diagram for illustrating a process of reducing a first color component block 2010 and its neighboring pixels 2020 according to the size of a second color component block corresponding to the first color component block, according to an exemplary embodiment.

Referring to FIG. 20, as described above, when a luminance block and a chrominance block have different sizes as in the 4:2:2 or 4:2:0 color format, the splitter 1410 reduces a luminance block and its neighboring pixels as a first color component to the size of a chrominance block as a second color component instead of using the luminance block and its neighboring pixels as they are, and then performs the above-described splitting on the reduced luminance block and the reduced neighboring pixel, thereby splitting the first color component block 2010 and the neighboring pixels 2020 into N segments.

In detail, when the first color component block 2010 has a 2N×2M size and a second color component block 2030 has a N×M size, the splitter 1410 may down-sample the pixel value of the first color component block 2010 in both horizontal and vertical directions as shown in Equations 4 and 5 below:

hor(i,j)=round(y(2*i,j)+Y(2*i+1,j))/2+0.5| [Equation 4]

where i=0, 1, . . . , N/2, j=0, 1, . . . , M/2.

ver(i,j)=round(hor(2*i,j)+hor(2*i+1,j))/2+0.5 [Equation 5]

where i=0, 1, . . . , N/2, j=0, 1, . . . , M/2, hor(i,j) denotes a horizontally down-sampled pixel value at a (i,j) location on the first color component block, and ver(i,j) denotes a pixel value obtained by vertically down-sampling the horizontally down-sampled pixel value of the first color component block. When down sampling using a 2-tap filter is performed vertically and horizontally as in Equation 5, the down-sampled first color component block 2010 has a N×M size. When a down-sampled first color component block having the same size as the second color component block 2030 is generated as described above, the splitter 1410 sets a reference value based on the pixel values of the down-sampled first color component block and compares the pixel values of the first color component block and its the neighboring pixel with the set reference value to split the first color component block and the neighboring pixels into the N segments, as described above with reference to Equations 1 through 3. The splitter 1410 splits a second color component block and its neighboring pixels into the same segments as those into which the first color component block and the neighboring pixels are split.

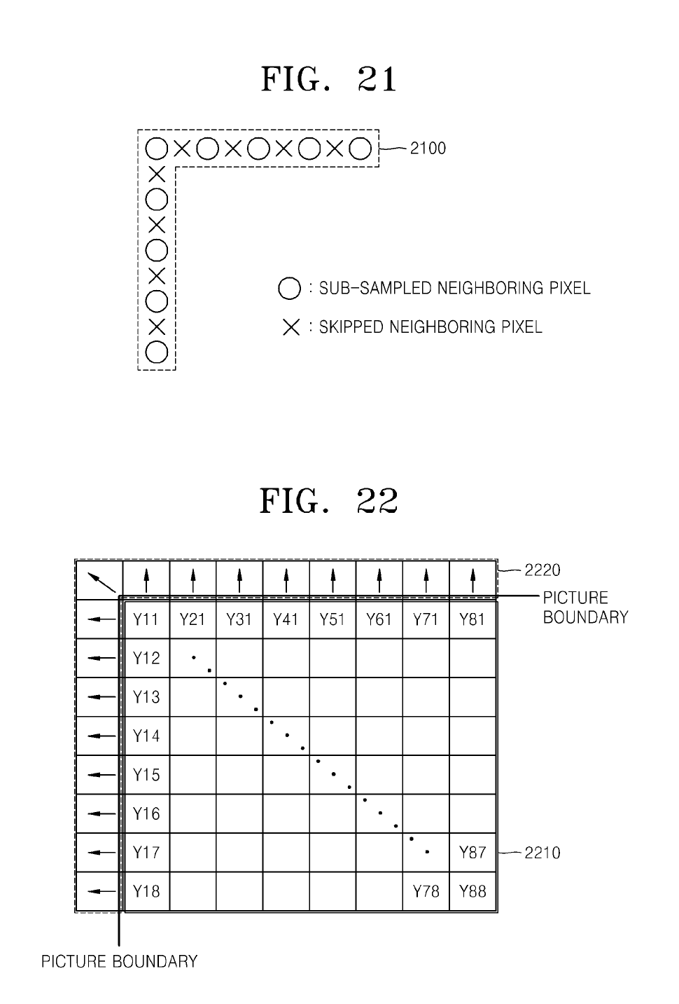

FIG. 21 is a reference diagram for illustrating a process of determining segment information of the neighboring pixels of a second color component block from segment information of the neighboring pixels of a first color component block, according to an exemplary embodiment. Referring to FIGS. 20 and 21, the splitter 1410 may sub-sample the neighboring pixels 2020 of the first color component block 2010 at a predetermined rate and then split the neighboring pixels 2040 of the second color component block 2030 according to segment information of the sub-sampled neighboring pixels of the first color component block 2010, in order to generate segment information of the neighboring pixels 2040 of the second color component block 2030. When the first color component block 2010 needs to be halved vertically and horizontally as shown in FIG. 20, the splitter 1410 sub-samples neighboring pixels 2100 of a first color component block at a rate of ½ as shown in FIG. 21 and acquires segment information of the neighboring pixels of a second color component block by using segment information of the sub-sampled neighboring pixels 2100.

FIG. 22 is a reference diagram for illustrating a method of processing a first color component block 2210 located on a picture boundary, according to an exemplary embodiment.

Referring to FIG. 22, when the first color component block 2210 is positioned on the edge of the left-most upper portion of a picture, no neighboring pixels may exist on the upper edge and the left edge of the first color component block 2210. As described above, to generate segment information of imaginary neighboring pixels 2220 of the first color component block 2210 positioned at the picture boundary, the splitter 1410 generates the imaginary neighboring pixels 2220 of the first color component block 2210 by extending pixels of the first color component block 2210 adjacent to the picture boundary with no neighboring pixels from among the pixels of the first color component block 2210 toward the picture boundary, and splits the first color component block 2210 and the imaginary neighboring pixels 2220 into N segments according to the pixel values of the first color component block 2210 and splits a second color component block corresponding to the first color component block 2210 and neighboring pixels of the second color component block into the same shapes of segments as the segments of the first color component block 2210 and the imaginary neighboring pixels 2220 according to the segment information of the first color component. Since the neighboring pixels of the pixels of the first color component block are used to acquire segment information of the neighboring pixels of the second color component block, the pixels of the first color component block may extend toward the pixel boundary in units of pixels.

When the second color component block and its neighboring pixels are split into N segments according to segment information of the first color component block corresponding to the second color component block and its neighboring pixels of the first color component block, the predictor 1420 predicts the N segments of the second color component block by using the neighboring pixels of the second color component block split into the N segments.

In detail, the predictor 1420 predicts the N segments of the second color component block, based on the mean of the pixel values of neighboring pixels belonging to an identical segment from among the neighboring pixels of the second color component block. In other words, when the neighboring pixels of the second color component block have been split into N segments Seg1, Seg1, . . . , and SegN and a mean of the pixel values of neighboring pixels of the second color component block belonging to the segment SegN is defined as Pel_N, the predictor 1420 predicts the pixel values of all of pixels belonging to the segment SegN from among the pixels of the second color component block to be Pel_N, thereby generating a prediction block. For example, referring back to FIG. 17, when a mean of the pixel values of the neighboring pixels 1741 classified into the segment Seg1 from among the neighboring pixels 1740 of the second color component block 1730 is defined as Pel_{—}1, and a mean of the pixel values of the neighboring pixels 1742 classified into the segment Seg2 from among the neighboring pixels 1740 of the second color component block 1730 is defined as Pel_{—}2, the predictor 1420 sets the pixel values of internal pixels 1731 classified into the segment Seg1 from among the internal pixels of the second color component block 1730 to be Pel_{—}1, and the pixel values of internal pixels 1732 classified into the segment Seg2 from among the internal pixels of the second color component block 1730 to be Pel_{—}2, thereby generating a prediction block of the second color component block 1730.

The prediction of the second color component block 1730 by the predictor 1420 may be expressed as in Equation 6 below:

$$\begin{matrix} & [ Equation 6 ] \\ pel\_ 0 = round ( {\sum }_{i = 0}^{N} cr ( i , 0 ) * ( 1 - S ( i , 0 ) ) + {\sum }_{j = 0}^{M} cr ( 0 , j ) * ( 1 - S ( 0 , j ) ) + N 0 ) * Round ( ( 1 〈 〈 8 ) / 2 N 0 ) 〉 〉 8 ) \\ pel\_ 1 = round ( {\sum }_{i = 0}^{N} cr ( i , 0 ) * S ( i , 0 ) + {\sum }_{j = 0}^{M} cr ( 0 , j ) * S ( 0 , j ) + N 1 ) * Round ( ( 1 〈 〈 8 ) / 2 N 1 ) 〉 〉 8 ) & \end{matrix}$$

In Equation 6, a second color component block has a N×M size, Cr(i,0) indicates the pixel values of neighboring pixels positioned on the upper side of the second color component block, Cr(0,j) indicates the pixel values of neighboring pixels positioned on the left side of the second color component block, S(i,0) indicates a value representing a segment of the neighboring pixels positioned on the upper side of the second color component block, and S(0,j) indicates a value representing a segment of the neighboring pixels positioned on the left side of the second color component block. Thus, similar to Equation 2, it is assumed that an S value of a pixel included in the segment Seg1 is 0 and an S value of a pixel included in the segment Seg2 is 1. In this case, Pel_{—}0 in Equation 6 denotes a mean of the pixel values of the neighboring pixels 1741 classified into the segment Seg1 from among the neighboring pixels 1740 of the second color component block 1730, and Pel_{—}1 in Equation 6 denotes a mean of the pixel values of the neighboring pixels 1742 classified into the segment Seg2 from among the neighboring pixels 1740 of the second color component block 1730.

Since a prediction block of the second color component block generated by the predictor 1420 is obtained by splitting pixels into segments, a large amount of high-frequency component may be included in the prediction block. Accordingly, filtering for removing the high-frequency component from the prediction block of the second color component block generated by the predictor 1420 may be additionally performed.

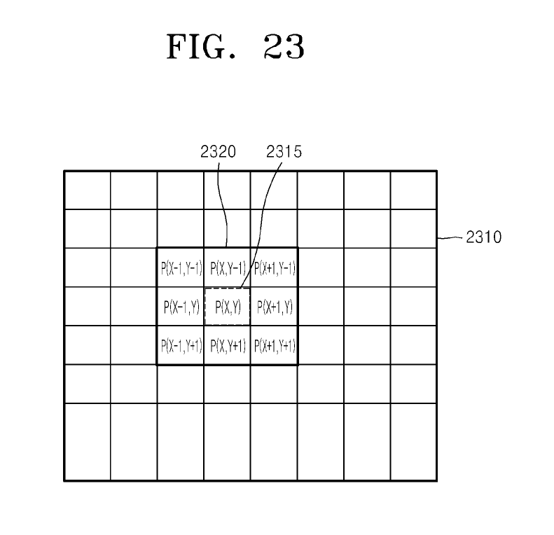

FIG. 23 is a reference diagram for illustrating a process of post-processing a prediction block 2310 of a second color component block, according to an exemplary embodiment.

Referring to FIG. 23, when the predictor 1420 generates the prediction block 2310 of the second color component block, the predictor 1420 may reduce the amount of high-frequency component existing in the prediction block 2310 of the second color component block by applying a predetermined filter to the prediction block 2310 of the second color component block. For example, as illustrated in FIG. 23, a filtering operation of changing a pixel value P(x,y) in the prediction block 2310 of the second color component block to a pixel value P′(x,y) according to Equation 7 may be additionally performed by using a 9-tap filter 2320.

P′(x,y)=(7*(P(x−1,y−1)+P(x,y−1)+P(x+1,y−1)+P(x−1,y)+P(x+1,y)+P(x−1,y+1)+P(x,y+1)+P(x+1,y+1))+P(x,y) [symbol] 3+(1 [symbol] 5) [symbol] 6 [Equation 7]

When a prediction block of the second color component block is generated based on a result of the prediction by the predictor 1420, the encoding apparatus 400 of FIG. 4 generates a prediction block generated by intra prediction and inter prediction and a residual as a difference between the second color component block and the prediction block, generates coefficients by transforming the residual into a frequency domain, and generates a bitstream by quantizing and entropy-encoding the coefficients. The entropy encoder 450 of FIG. 4 may add index information representing whether the current block is the second color component block predicted using segment information of the first color component according to the above-described exemplary embodiments, to the bitstream as prediction information of the current block. For example, 0 may be set to represent a prediction block predicted without applying exemplary embodiments, and 1 may be set to represent a prediction block predicted by applying exemplary embodiments.

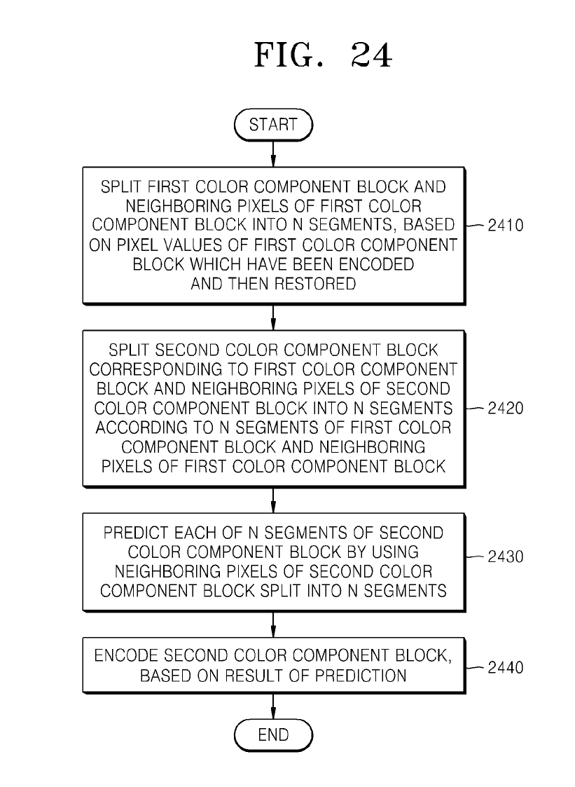

FIG. 24 is a flowchart illustrating a video encoding method according to an exemplary embodiment.

Referring to FIG. 24, in operation 2410, the splitter 1410 splits a first color component block and neighboring pixels of the first color component block into N segments, based on the pixel values of the first color component block which have been encoded and then restored. As described above, the splitter 1410 may set (N−1) reference values based on the pixel values of the first color component block and classify the pixels of the first color component block and the neighboring pixels of the first color component block according to the (N−1) reference values to generate N segments. A mean of the pixels of the first color component block may be used as the reference values. When the first color component block and a second color component block have different sizes, the splitter 1410 may down-sample the first color component block to the size of the second color component block in consideration of the size difference, sub-sample the neighboring pixels of the first color component block at a predetermined rate to generate sub-sampled neighboring pixels of the first color component block, and then split the down-sampled first color component block and the sub-sampled neighboring pixels of the first color component block into N segments by using a mean of the pixel values of the down-sampled first color component block.

In operation 2420, the splitter 1410 splits the second color component block and the neighboring pixels of the second color component block into N segments according to the N segments of the first color component block and the neighboring pixels of the first color component block. As described above, the splitter 1410 splits the second color component block and the neighboring pixels of the second color component block into the N segments according to the N segments of the first color component block and the neighboring pixels of the first color component block.

In operation 2430, the predictor 1420 predicts each of the N segments of the second color component block by using the neighboring pixels of the second color component block split into the N segments, thereby generating a prediction block of the second color component block. The predictor 1420 generates the prediction block of the second color component block by setting a mean value of the pixels values of neighboring pixels belonging to an identical segment from among the neighboring pixels of the second color component block.

In operation 2440, a residual signal corresponding to a difference between the prediction block of the second color component block generated by the predictor 1420 and the original block is encoded through transformation, quantization, and entropy-encoding.

A video encoding apparatus according to an exemplary embodiment has the same or similar construction as the video encoding apparatus 1400 of FIG. 14, and is included in the intra predictor 550 of FIG. 5 to perform a prediction method based on the above-described exemplary embodiments.

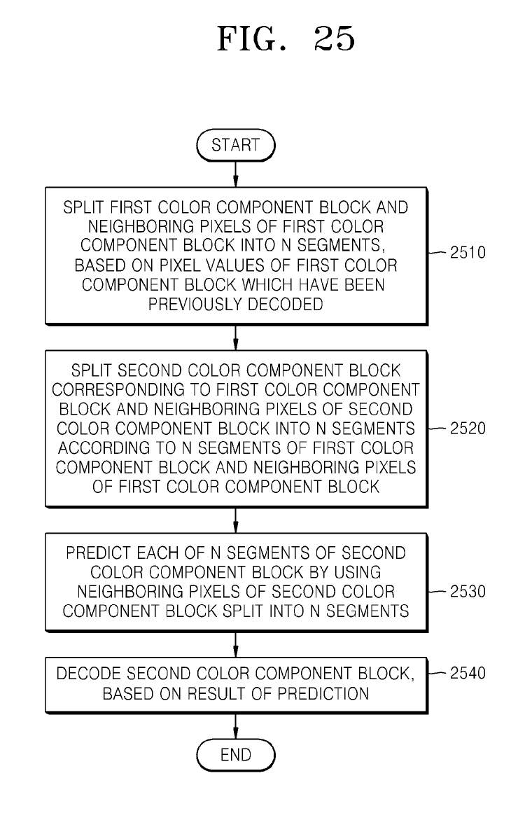

FIG. 25 is a flowchart illustrating a video decoding method according to an exemplary embodiment.

Referring to FIG. 25, in operation 2510, the splitter 1410 splits a first color component block and neighboring pixels of the first color component block into N segments, based on the pixel values of the first color component block which have been previously decoded. As described above, the splitter 1410 may set (N−1) reference values based on the pixel values of the first color component block and classify the pixels of the first color component block and the neighboring pixels of the first color component block according to the (N−1) reference values to generate N segments. A mean of the pixels of the first color component block may be used as the reference values. When the first color component block and a second color component block have different sizes, the splitter 1410 may down-sample the first color component block to the size of the second color component block in consideration of the size difference, sub-sample the neighboring pixels of the first color component block at a predetermined rate to generate sub-sampled neighboring pixels of the first color component block, and then split the down-sampled first color component block and the sub-sampled neighboring pixels of the first color component block into N segments by using a mean of the pixel values of the down-sampled first color component block.

In operation 2520, the splitter 1410 splits the second color component block and the neighboring pixels of the second color component block into N segments according to the N segments of the first color component block and the neighboring pixels of the first color component block. As described above, the splitter 1410 splits the second color component block and the neighboring pixels of the second color component block into the N segments according to the N segments of the first color component block and the neighboring pixels of the first color component block.

In operation 2530, the predictor 1420 predicts each of the N segments of the second color component block by using the neighboring pixels of the second color component block split into the N segments, thereby generating a prediction block of the second color component block. The predictor 1420 generates the prediction block of the second color component block by setting a mean value of the pixels values of neighboring pixels belonging to an identical segment from among the neighboring pixels of the second color component block.

In operation 2540, a prediction block of the second color component block generated by the predictor 1420 is added to a residual signal extracted from a bitstream and decoded, thereby decoding the second color component block.

One or more exemplary embodiments can also be embodied as computer readable codes on a computer readable recording medium. The computer readable recording medium is any data storage device that can store data which can be thereafter read by a computer system. Examples of the computer readable recording medium include read-only memory (ROM), random-access memory (RAM), CD-ROMs, magnetic tapes, floppy disks, optical data storage devices, etc. The computer readable recording medium can also be distributed over network coupled computer systems so that the computer readable code is stored and executed in a distributed fashion.

While exemplary embodiments have been particularly shown and described above, it will be understood by those of ordinary skill in the art that various changes in form and details may be made therein without departing from the spirit and scope of the present inventive concept as defined by the following claims.

What is claimed is:

1. A method of encoding a video signal including a plurality of color components, the method comprising:
splitting a first color component block and neighboring pixels of the first color component block into N segments, where N is an integer, based on pixel values of the first color component block which have been previously encoded and then restored;
splitting a second color component block, corresponding to the first color component block, and neighboring pixels of the second color component block into N segments according to the N segments of the first color component block and the neighboring pixels of the first color component block;
predicting the N segments of the second color component block by using the neighboring pixels of the second color component block split into the N segments; and
encoding the second color component block, based on a result of the predicting.

2. The method of claim 1, wherein the splitting of the first color component block and the neighboring pixels of the first color component block into the N segments comprises:
determining (N−1) reference values, based on the pixel values of the first color component block; and
classifying pixels of the first color component block and the neighboring pixels of the first color component block according to the determined (N−1) reference values.

3. The method of claim 2, wherein the determining of the (N−1) reference values comprises determining the (N−1) reference values according to a mean of the pixel values of the first color component block.

4. The method of claim 1, wherein the splitting of the first color component block and the neighboring pixels of the first color component block into the N segments comprises:
down-sampling the first color component block to a size of the second color component block in consideration of a difference between a size of the first color component block and the size of the second color component block;
generating sub-sampled neighboring pixels of the down-sampled first color component block by sub-sampling the neighboring pixels of the first color component block at a predetermined rate; and
splitting the down-sampled first color component block and the generated sub-sampled neighboring pixels into N segments by using a mean of pixel values of the down-sampled first color component block.

5. The method of claim 4, further comprising:
calculating mean values of the N segments of the first color component block; and
re-classifying the pixels of the first color component block and the neighboring pixels of the first color component block so that the pixels of the first color component block and the neighboring pixels are included in a segment having most similar mean values among the N segments.

6. The method of claim 4, wherein the splitting of the second color component block and the neighboring pixels of the second color component block into the N segments comprises splitting the second color component block and the neighboring pixels of the second color component block into the N segments according to the N segments of the down-sampled first color component block and the generated sub-sampled neighboring pixels.

7. The method of claim 1, wherein the predicting of the N segments of the second color component block comprises predicting the N segments of the second color component block, based on a mean of pixel values of neighboring pixels belonging to an identical segment from among the neighboring pixels of the second color component block.

8. The method of claim 1, wherein, when the first color component block is positioned on a picture boundary and no neighboring pixels of the first color component block exist, imaginary neighboring pixels of the first color component block are generated by extending pixels of the first color component block adjacent to the picture boundary, from among pixels of the first color component block, toward the picture boundary.

9. The method of claim 8, wherein the pixels of the first color component block adjacent to the picture boundary are extended toward the picture boundary in units of pixels.

10. The method of claim 1, further comprising performing filtering with respect to the second color component block predicted in units of the N segments.

11. A method of decoding a video signal including a plurality of color components, the method comprising:
splitting a first color component block and neighboring pixels of the first color component block into N segments, where N is an integer, based on pixel values of the first color component block which have been previously decoded;
splitting a second color component block, corresponding to the first color component block, and neighboring pixels of the second color component block into N segments according to the N segments of the first color component block and the neighboring pixels of the first color component block;
predicting the N segments of the second color component block by using the neighboring pixels of the second color component block split into the N segments; and
decoding the second color component block, based on a result of the predicting.

12. The method of claim 11, wherein the splitting of the first color component block and the neighboring pixels of the first color component block into the N segments comprises:
determining (N−1) reference values, based on the pixel values of the first color component block; and
classifying pixels of the first color component block and the neighboring pixels of the first color component block according to the determined (N−1) reference values.

13. The method of claim 12, wherein the determining of the (N−1) reference values comprises determining the (N−1) reference values according to a mean of the pixel values of the first color component block.

14. The method of claim 11, wherein the splitting of the first color component block and the neighboring pixels of the first color component block into the N segments comprises:
down-sampling the first color component block to a size of the second color component block in consideration of a difference between a size of the first color component block and the size of the second color component block;
generating sub-sampled neighboring pixels of the down-sampled first color component block by sub-sampling the neighboring pixels of the first color component block at a predetermined rate; and
splitting the down-sampled first color component block and the generated sub-sampled neighboring pixels into N segments by using a mean of pixel values of the down-sampled first color component block.

15. The method of claim 14, further comprising:
calculating mean values of the N segments of the first color component block; and
re-classifying the pixels of the first color component block and the neighboring pixels of the first color component block so that the pixels of the first color component block and the neighboring pixels are included in a segment having most similar mean values among the N segments.

16. The method of claim 14, wherein the splitting of the second color component block and the neighboring pixels of the second color component block into the N segments comprises splitting the second color component block and the neighboring pixels of the second color component block into the N segments according to the N segments of the down-sampled first color component block and the generated sub-sampled neighboring pixels.

17. The method of claim 11, wherein the predicting of the N segments of the second color component block comprises predicting the N segments of the second color component block, based on a mean of pixel values of neighboring pixels belonging to an identical segment from among the neighboring pixels of the second color component block.

18. The method of claim 11, wherein, when the first color component block is positioned on a picture boundary and no neighboring pixels of the first color component block exist, imaginary neighboring pixels of the first color component block are generated by extending pixels of the first color component block adjacent to the picture boundary, from among pixels of the first color component block, toward the picture boundary.

19. The method of claim 18, wherein the pixels of the first color component block adjacent to the picture boundary are extended toward the picture boundary in units of pixels.

20. The method of claim 11, further comprising performing filtering with respect to the second color component block predicted in units of the N segments.

21. An apparatus for encoding a video signal including a plurality of color components, the apparatus comprising:
a splitter which splits a first color component block and neighboring pixels of the first color component block into N segments, where N is an integer, based on pixel values of the first color component block which have been previously encoded and then restored, and splits a second color component block, corresponding to the first color component block, and neighboring pixels of the second color component block into N segments according to the N segments of the first color component block and the neighboring pixels of the first color component block; and
a predictor which predicts the N segments of the second color component block by using the neighboring pixels of the second color component block split into the N segments.

22. An apparatus for decoding a video signal including a plurality of color components, the apparatus comprising:
a splitter which splits a first color component block and neighboring pixels of the first color component block into N segments, where N is an integer, based on pixel values of the first color component block which have been previously decoded, and splits a second color component block, corresponding to the first color component block, and neighboring pixels of the second color component block into N segments according to the N segments of the first color component block and the neighboring pixels of the first color component block; and
a predictor which predicts the N segments of the second color component block by using the neighboring pixels of the second color component block split into the N segments.

23. A computer-readable recording medium having recorded thereon a program for executing the method of claim 1.

24. A computer-readable recording medium having recorded thereon a program for executing the method of claim 11.
